(19) United States
(12) Patent Application Publication
(10) Pub. No.: US 2005/0262013 A1
(43) Pub. Date: Nov. 24, 2005

(54) System and method for analyzing risk and profitability of non-recourse loans

(76) Inventors: Mark W. Guthner, Chatham, NJ (US); Iain C. MacLachlan, Newtown Victoria (AU)

Correspondence Address: Thomas F Bergert;Williams Mullen, Suite 700, 8270 Greensboro Drive, McLean, VA, 22102, US

(21) Appl. No.: 10/344,550

(22) PCT Filed: Oct. 16, 2001
(86) PCT No.: PCT/US01/42764

§ 371 Date: Nov. 6, 2003

(51) Int. Cl. G06F 17/60

(52) U.S. Cl. 705/38

(57) ABSTRACT

A system and method for assisting lenders in making decisions related to non-recourse loans employs a model which considers each risk relevant to the loan determination, including commercial and country risk factors. From this analysis, the present invention can determine the estimated default frequency (EDF), the loss given default (LGD), volatility of the loss, and can recommend total provision and economic capital outlays for the lender for the given non-recourse loan. From this information, the present invention can also be used to determine a credit rating and profitability measures for the given loan.

### TECHNICAL FIELD

The present invention relates to banking, and more particularly, to a system and method for improved loan decision-making through risk analysis.

### BACKGROUND ART

Bank loans take many forms. For example, banks loan money to consumers for their home mortgage, car financing, and other major purchases. Banks also issue loans to corporations to assist with new product development, working capital, debt payments, and other general corporate operating expenses. These types of corporate loans are considered “balance sheet” loans because the loan is disclosed on the corporate balance sheet and the lending entity would have recourse against the other assets of the business should the corporation default on the loan. Banks also issue “non-recourse” loans to corporations, which are generally tied to a particular project, held in a special purpose vehicle, and for which the lending entity does not have recourse against other assets of the parent corporation in the event of default.

Prior to issuing loans, banks typically conduct a risk analysis related to the loan to determine whether the applicant is credit worthy, how much the bank should loan and at what price. Analyzing the risk of generic corporate loans can be approached through the use of actuarial factors derived from historical experience. This is possible because the characteristics of these loans have more in common than they have differences. For a given credit risk rating, be it by Moody's™, Standard & Poor's™ (S&P)™ or ANZ's™ CCR™ (Customer Credit Rating), the probability that a borrower will default on its debt can be estimated based on historical default rates. Furthermore, historical default experience provide insight into how much a lending entity can expect to lose in the event of default (Loss Given Default, or LGD), given a loan's standing within the borrower's capital structure, and the industry of the borrowing entity. One key to this method of analysis is that the pool of loans being analyzed is reasonably homogeneous and the structural characteristics of individual loans are generic.

By contrast, non-recourse loans, such as project or structured-corporate lending, are not homogeneous and typically involve complex contractual arrangements with unique characteristics, reflecting the involvement of many stakeholders. The risk profile of one loan provides very little insight into the risk profile of another loan. This is, in fact, the intention of structured finance lending. All economic enterprises have some level of financial and operating risk. Structured finance techniques carve up that risk and allocate it to the parties that are most able to accept and manage it. As a result, each loan has its own unique risk profile and must be analyzed taking into consideration the distinctive elements of the underlying project and loan itself.

A proper framework and execution of financial analysis related to structured infrastructure lending is therefore crucial for a number of reasons. First, it helps the lender understand the risks inherent in a particular transaction. Once the risks are assessed, these risks can be priced to determine the loan's net income after the cost of capital (NIACC) as a measure of the loan's economic value added to the lender. With a level playing field, one can objectively determine what deals should be pursued on a day-to-day basis. Second, it provides the lender with the necessary insight into several factors at the individual loan and portfolio levels, including how much risk the enterprise is taking, how much they can expect to earn by originating, executing and holding these loans, how much economic capital they should hold to ensure the survival of the institution, and how much they should provision for expected losses. Ultimately, this helps determine how large the portfolio can and should be relative to a financial institutions available capital and how it should be positioned strategically.

Through such analyses, credit ratings can be determined to give a lender a relative risk rating for a particular loan as measured against a standardized loan risk rating system. As discussed, credit models are used to compute provisioning and economic capital for financial institutions. Unfortunately, the current methodology for credit rating project finance loans is entirely qualitative. For example, a project may be rated based upon which country it is located in, which industry it is categorized in, what leverage exists, what supplier may be involved, who the off-taker is, and other factors. From these factors, an educated guess as to the credit rating to apply is often made, and calculations can determine provisioning and economic capital based on historical default rates and rating migration experience. In such a case, a credit rating can be assigned, such as the equivalent of A3 on a Moody's scale, for example, along with the seniority on the loan, such as “senior unsecured” for example, and an industry designation. A major drawback, however, is that it is unknown how accurate the ratings are, and it is unlikely that the historical default rates and ratings migration matrices will accurately reflect future expectations. This can and does cause suboptimal decision-making at the lender level.

To understand the risk and profitability of a loan, the elements of expected default frequency (EDF), loss given default (LGD), and volatility (or uncertainty) of loss (VoL) are estimated. With values for these elements, a number of important measures can be determined, including a customer credit rating (CR), a loss indicator (LI), expected loss (EL), economic capital (EC), net income after cost of capital (NIACC), and risk adjusted return on capital (RAROC).

Examples of decision-assisting systems for use in banking and other areas are described in the following U.S. Pat. Nos.: 4,989,141 to Lyons et al.; 5,062,055 to Chinnaswamy et al.; 5,189,606 to Burns et al.; 5,361,201 to Jost et al.; 5,696,907 to Tom; 5,774,883 to Anderson et al.; 5,966,700 to Gould et al.; 6,078,903 to Kealhofer; 6,078,905 to Pich-LeWinter; 6,112,190 to Fletcher et al.; and 6,119,103 to Basch et al. Other examples are described in International patent applications WO/99/09517 to Fletcher et al., and WO/99/48036 to Jammal et al. None of the above references describes a method which can accurately estimate risk and profitability of a project finance loan through the analysis of commercial and country risks, to assist in the decision-making of the lending entity and to assist with accurately determining a provisioning amount and an economic capital amount.

### DISCLOSURE OF INVENTION

As a general framework for measuring expected loss (EL) and economic capital (EC) of a drawn loan with country risk, a number of basic issues can be addressed. For example, the likelihood that the project will default for commercial/economic reasons, or the commercial default, is considered. The commercial default is a function of the economic need of the project (i.e. demand for what is produced), the uncertainty of the economic variables driving the project (commodity prices, interest of inflation rates, etc.), the contractual arrangements of the project (interest rate and currency hedges, supply and offtake agreements), and the quality and experience of the participants (sponsors, operators, off-takers, suppliers, etc.). If the project defaults for commercial reasons, the severity of loss that can be expected is a function of the cause of the default and is called the commercial loss given default (LGD). LGD is dependent on the cause of the default. The LGD actually suffered will be impacted by whether the project failed because of a lack of raw materials or a prolonged spike in the price of the materials, whether a cheaper substitute entered the market, or whether interest rates spiked, etc. The commercial loss given default can be determined by estimating the present value of a project's expected cash flow in a default scenario relative to the amount of debt outstanding, the location of the project (i.e. country of location), the relative importance of the project to the local government, and the participation by Export Credit Agencies (ECAs) and Multi-Lateral Institutions (MLs) and the reason for default. Participation by guarantors such as ECAs and/or MLs generally reduces the overall loan risk of a project.

There are two broad categories of Country Risk. They are (1) the possibility of cross border default and (2) default caused by Political Violence. The risk of a cross border default is characterized by the government's ability and willingness to service foreign currency obligations. The risk of default caused by political violence is characterized by war, expropriation, regulatory instability, property rights, and transparency (or lack thereof) in the legal systems, for example. Total Country Risk is the sum of these two broad elements (EDF_{COUNTRY}=EDF_{CROSS BORDER}+EDF_{POLITICAL VIOLENCE}). A proprietary Country Index (CI) can be used as a measure of this risk as can ratings provided by Moody's and S&P or other rating agencies. If the country defaults on its cross-border debt, the severity of loss that can be expected is called the country loss given default (i.e. Country LGD). Estimates of Country LGD are based on historical rescheduling agreements and expropriation events, and are influenced by participation by multi-lateral institutions.

The likelihood that the project suffers a commercial default and country default at the same time is called a joint EDF. This is driven by the default correlation between the commercial performance of the project and country specific risks. The correlation is generally driven by the industry in question along with the existence of cross-border currency flows. If a simultaneous (commercial & country) default occurs, the level of loss that can be expected is called the joint loss given default (Joint LGD). This loss is a function of LGD estimates obtained individually for the country LGD and the commercial LGD.

The level of uncertainty in the EDF and LGD estimates described is also of interest in reaching a loan determination. The volatility of EDF (which can be represented as a binomial function) can be computed mathematically, and the volatility of LGD requires statistical estimation based on sampled data, to be discussed hereinafter.

Expected Loss (EL) represents the level of credit losses expected over the life of the loan or specific time horizon. Actual loss for a portfolio of loans may differ from expected loss from period to period, but should on average converge to expected loss over a business cycle. EL is applied only to loans that are not yet in default, as loans already in default are considered as losses for a previous period. From a practical standpoint, Expected Loss can be calculated for a specific loan or transaction as the product of the EDF, the LGD, and the Exposure Amount (EA). FIG. 2A shows how EL may be determined in accordance with the method of the present invention.

Since there are a number of ways a project can default, a project loan can be thought of as having a “portfolio” of risks. In simple terms, the expected loss for country default risk and commercial default risks associated with counter party default are calculated independently. Statistical mathematics can then be used to sum the effects of all the sources of risk based upon their joint probability or correlation.

Economic Capital

Actual losses can and do differ from expected losses. They can be better or worse in any one period. As long as EL is accurately estimated, Expected Losses and Actual Losses will converge over the long term. Economic Capital represents funds put aside by a financial institution to ensure that if losses are worse than expected in any one period, enterprise solvency is ensured. Economic Capital (EC) is, therefore, a function of the uncertainty of the expected loss estimate (i.e. Volatility of Loss (VoL)) for the entire portfolio. When analyzing any one loan, the required level of economic capital is defined by its marginal contribution of risk to the overall volatility of the portfolio. In other words, if a loan improves the diversification of the loan portfolio, the economic capital needed to support that loan is low. If, on the other hand, the loan adds to an already high concentration, it provides little diversification benefit and a large amount of capital is required. As described herein, Volatility of Loss (VoL) and Unexpected Loss (UL) are used interchangeably. Both are equal to one standard deviation around Expected Loss (EL). FIG. 2B is an example distribution chart 62 showing EL, VoL, and Economic Capital.

Having defined UL (and VoL) as one standard deviation from EL, one can then determine the desired level of default risk the lender is willing to carry. While minimizing this figure would appear desirable, there is a trade-off between a lender's credit rating and their cost of capital. A Capital Multiplier (CM) represents the number of standard deviations that are needed to absorb an annual loss with sufficient confidence to match the default probability of the financial institution's target credit rating. For example, one can assume a CM of 9.0 is needed to maintain an AA credit rating from S&P. Then, before diversification benefits, the financial institution needs capital equal to 9.0×UL for the loan in question to be sufficiently confident that it will have enough capital to maintain solvency, and absorb all credit losses given any economic scenario.

Application to Structured Infrastructure Lending

While the basic theoretical framework is straightforward, its application to structured infrastructure lending is more complex. This is because there is more than one way for a commercial and/or country default to occur. When considering the risk drivers of project finance lending, one must consider the commercial risk drivers of construction, operations (Technical Reasons), supply or supplier, off-taker, refinance and macro-economic factors. Country risk drivers include Political Violence (expropriation, war, and potential for regulatory instability, etc.), as well as Cross Border (Currency Inconvertibility) risks.

It is thus one object of the present invention to provide a system and method for accurately assessing the risk of a project finance loan.

It is another object of the present invention to assist lenders in making loan decisions related to project finance.

It is yet another object of the present invention to provide a system and method for accurately assessing the profitability of a project finance loan.

It is a further object of the present invention to improve systems for credit rating of project finance loans.

It is another object of the present invention to improve accuracy and predictability of provisioning and economic capital computations in connection with bank lending.

By the present invention, there is thus provided a system and method for assisting lenders in making decisions related to project finance loans. The present invention employs a model which considers each risk relevant to the loan determination, including commercial/economic and country risks. From this analysis, the present invention can determine the estimated default frequency (EDF), the loss given default (LGD), volatility of the loss (VoL), and can recommend total provision and economic capital outlays for the lender for the given project finance loan. From this information, the present invention can also be used to determine a credit rating and profitability measures for the given project loan.

In one embodiment of the present invention, to compute Expected Loss, Economic Capital, NIACC and RAROC for a given project, an EDF, LGD and Volatility of Loss is needed for each of the factors above, along with the appropriate correlation between these events. By the present invention, these factors are modeled so as to generate accurate figures to assist in loan decision making. Risks introduced by macro-economic factors, (off-take price & volume, interest & foreign exchange rates, for example) can be computed outside the model of the present invention using a Monte Carlo process. The results of this analysis can be input into the model of the present invention for incorporation into the risk rating, NIACC and RAROC analysis. To quantify the macro-economic analysis, a cash flow model can be built and thousands of scenarios sampled using a random simulation approach, such as a Monte Carlo analysis, for example. All other risks are estimated and included in the analysis using the Risk Integration Model (RIM™) of the present invention.

The risk integration model (RIM™) included as part of the present invention is an analytical tool used to perform the risk analysis to compute expected profitability estimates and a credit rating. The credit rating can be computed year-by-year to determine the time and level of peak risk, as well as the average risk rating, over the life of the loan. The same can be done for the profitability analysis. The RIM™ of the present invention assembles the relevant risk factors to assess the overall risk and profitability of a project loan. Making a series of choices from an input menu that describes the characteristics of the loan initiates the loan evaluation. In one embodiment of the present invention, the model considers the risk of early repayment. A statistical model is built-in, to assess the probability the loan will be called at any point in the life of the loan. As a result, profitability is not only computed on a credit risk adjusted basis, but on a call-adjusted basis as well. In another embodiment of the invention, the model considers factors related to refinancing. A statistical model is built in to assess the possibility that the loan will not be refinanceable at the contracted maturity date of the loan.

### BRIEF DESCRIPTION OF DRAWINGS

FIG. 1 is a system diagram illustrating inputs and outputs of the risk integration model of the present invention in accordance with one embodiment of the present invention.

FIG. 2A is a diagram showing various default states of a loan after it has been made, and a method of determining expected loss for a loan transaction using the method of the present invention.

FIG. 2B is a diagram showing a sample distribution of credit loss for a hypothetical loan.

FIGS. 3A and 3B are sample sets of estimated default frequency (EDF) values as may be developed in accordance with the present invention.

FIG. 4 is a sample set of historical default rates as may be used in accordance with the present invention.

FIGS. 5A, 5B, 6A and 6C show sample input pages for use in accordance with one embodiment of the present invention.

FIG. 7A shows a sample table for use in inputting a specific insurer in accordance with one embodiment of the present invention.

FIG. 7B shows a sample partial table of booking points and associated tax rates and hurdle rates for use in connection with the present invention.

FIGS. 8A and 8B show a sample input page for use with analyzing macro-economic factors in accordance with one embodiment of the present invention.

FIGS. 8C and 8D show a sample partial input page including results from a macro-economic factor analysis which can be used in connection with a loan risk assessment in accordance with one embodiment of the present invention.

FIGS. 9 and 10 show sample input pages for use in determining country risk in accordance with one embodiment of the present invention.

FIG. 11 shows a sample worksheet for determining a country risk rating in accordance with one embodiment of the present invention.

FIGS. 12 and 13 show sample input pages for use in determining construction risk factors in accordance with one embodiment of the present invention.

FIG. 14 shows a sample rating table showing sample construction and operating phase ratings for a variety of project types in accordance with the present invention.

FIGS. 15 through 27 show sample scoring and rating tables for use with various risk factors of the present invention.

FIGS. 28A and 28B show sample tables of the probability of refinance failure in accordance with one embodiment of the present invention.

FIG. 29 shows a sample table of EDF vectors in connection with insurance types and refinance risk for use in accordance with the present invention.

FIGS. 30A and 30B show sample summary tables of EDF values for use in connection with the present invention.

FIGS. 31A, 31B and 31C show sample output reports for use in connection with the present invention.

FIGS. 32 and 33 show sample rating tables for loss indicator and security indicator ratings in accordance with one embodiment of the present invention.

FIG. 34 shows a sample table of LGD values related to the position of a loan within capital structure for use in connection with the present invention.

FIG. 35 shows a sample summary table of LGD values for use in connection with the present invention.

FIGS. 36 through 38 show sample summary tables representing values for expected loss, volatility of LGD, and unexpected loss for use in connection with the present invention.

FIGS. 39A and 39B show sample calculation tables for use in calculating NIACC in accordance with one embodiment of the present invention.

FIGS. 40A, 40B and 40C shows sample tables for use in summarizing analysis for various risk factors and measures in accordance with the present invention.

FIG. 41 shows a sample assumptions table having measures for various LGD and standard deviations of LGD in accordance with one embodiment of the present invention.

FIGS. 42A and 42B show sample calculation tables for computing profitability measures in accordance with one embodiment of the present invention.

FIGS. 43 through 50 show sample output graphs in accordance with one embodiment of the present invention.

### MODES FOR CARRYING OUT THE INVENTION

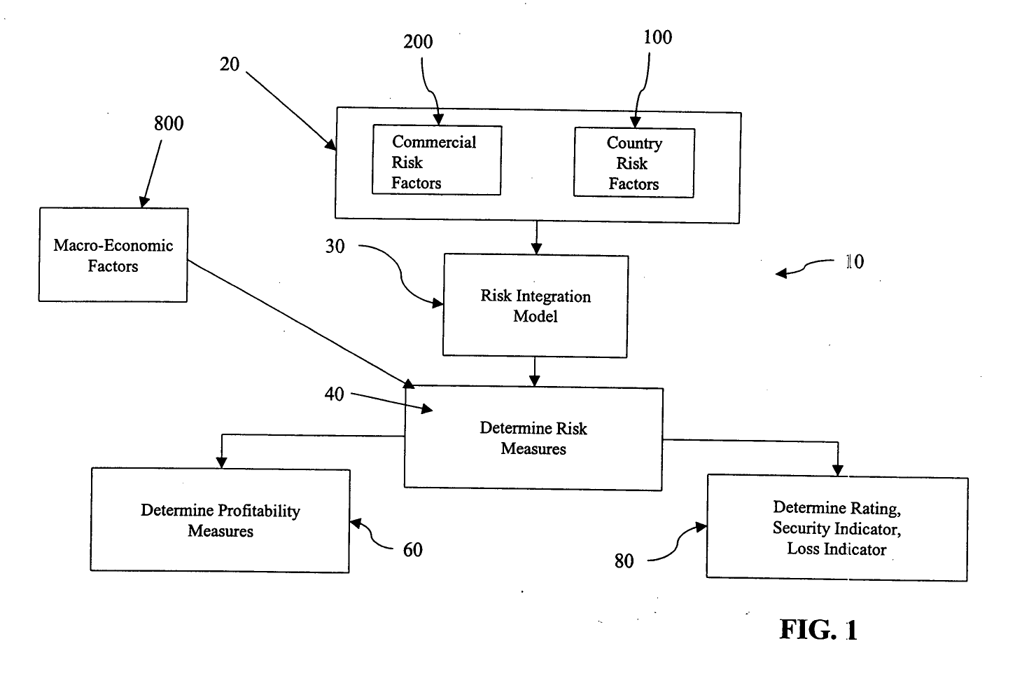

As shown in FIGS. 1 through 50, the present invention provides a system 10 for receiving various risk factor inputs 20 related to project finance loans and providing meaningful output measures designed to assist lenders in making decisions with regard to these loans. Inputs can include factors of commercial risk, shown generally at 200, factors of country risk, shown generally at 100, and macro-economic factors, shown generally at 800. Macro-economic factors can be considered a commercial risk factor and, in one embodiment of the present invention, are estimated separately from the other commercial factors. Once the input elements are received, a risk model 30 in accordance with the present invention is used to determine various risk measures 40, profitability measures 60, and rating and provisioning measures 80 to assist in the lender's decision-making.

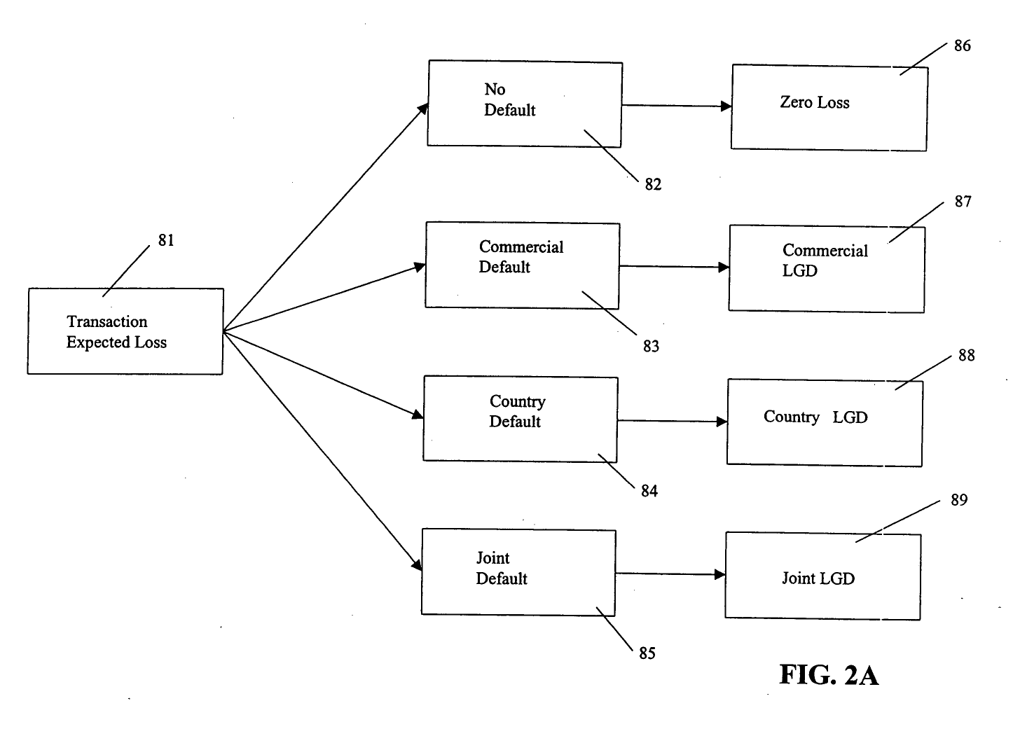

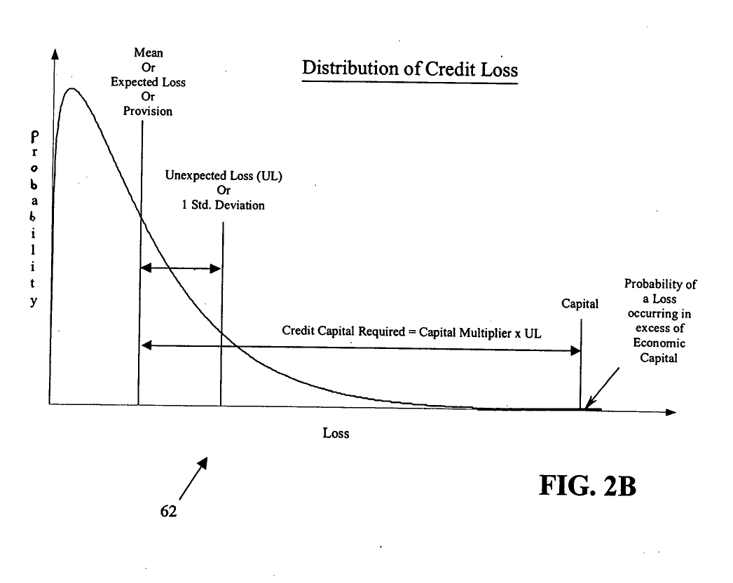

In one embodiment of the invention, for both types of inputs described, the risk measures 40 determined can include an estimated default frequency (EDF), loss given default (LGD), and volatility of loss (VoL). The decision-making measures 60, 80 which can be determined as a result of the obtained risk measures include the customer credit rating (CCR), loss given default indicator (LI), security indicator (SI), expected loss (EL), economic capital (EC), net income after cost of capital (NIACC), and risk adjusted return on capital (RAROC). As shown in FIG. 2A, EL 81 can be determined by considering the various scenarios of default, such as no default 82, commercial default 83, country default 84, and joint commercial and country default 85. Taking those default scenario probabilities, the LGDs 86, 87, 88, 89 associated therewith, and the amount of capital exposed, EL can be determined. The decision-assisting measures 60, 80 will be discussed more completely hereinafter. In one embodiment of the invention, the calculations, tables, and graphs can be performed and represented on a computer spreadsheet, such as the commercially available Microsoft™ Excel™ spreadsheet, from Microsoft Corporation, Redmond, Wash. In another embodiment of the invention, the invention can be carried out as a dedicated software program written in C++, VISUAL BASIC, or SMALLTALK, for example, which may be accessible at an individual PC or over a network such as the Internet, for example.

An attribute of the present invention which contributes to the accuracy of the obtained results is that the present invention counts each risk factor associated with a prospective loan once, and only once. Thus, within the country risk factors 100, the risk of political violence and the risk of currency inconvertibility are considered. Within the commercial risk factors 200, the risks associated with engineering and construction, operation, suppliers, off-takers, refinance, and macro-economic factors are considered. In one embodiment of the present invention, each of the commercial risk factors are modeled within the system of the present invention except for the macro-economic factors, which can be modeled externally, such as by Monte Carlo simulation, and incorporated into the valuation of the risk elements. The present invention also considers the possibility of joint commercial and country risk factors contributing to the default of a prospective loan.

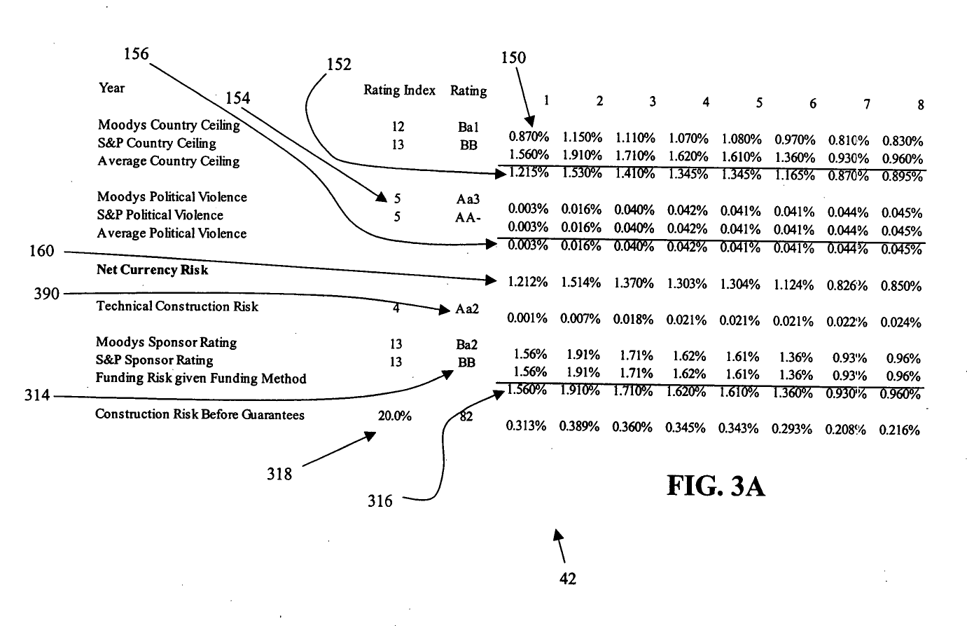

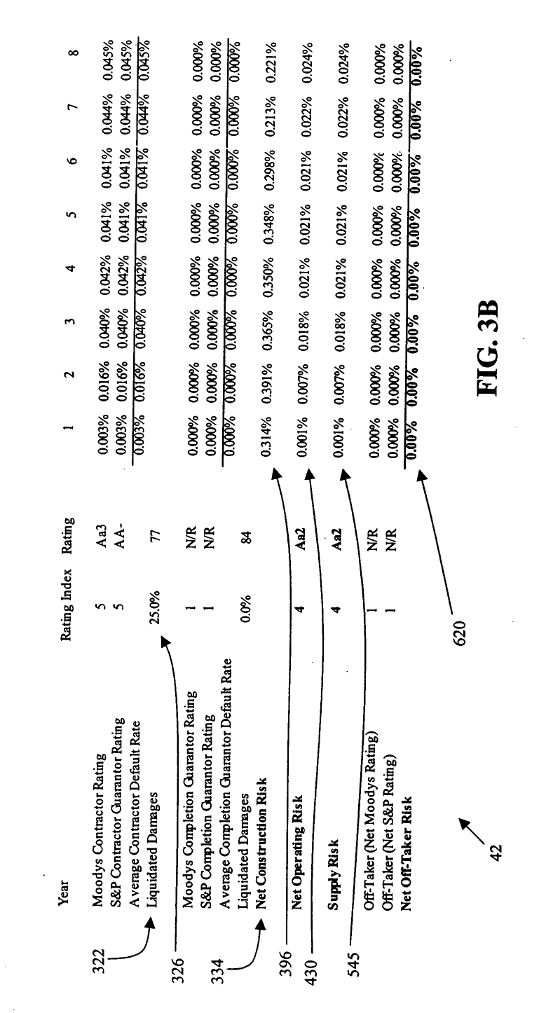

As described, for each risk factor, several risk measures can be determined, including EDF, LGD, and VoL. These measures can be obtained for each year the project is in construction or operation. FIGS. 3A and 3B is a sample summary EDF vector table, which can be populated according to the methods described herein. As shown in the EDF value table 42 in FIGS. 3A and 3B, for example, the EDF vector 430 based on the factor of supply/supplier failure is 0.001% in project year 1, 0.007% in project year 2, 0.018% in project year 3, and so on. This EDF vector is a stream of EDF values associated with default probabilities based on supplier failure over time. When added to the other risk factor EDF vectors, the present invention can provide a combined EDF vector representing the EDF for each year of the project. Adding together the EDF for each year of the project results in the total or cumulative EDF for the project. This calculation can be performed as straight addition (e.g. EDF_{A}+EDF_{B}) or as a compounded calculation (e.g., (1+EDF_{A}×(1+EDF_{B})−1). Total EDF is a useful measure by the prospective lender in the loan decision analysis. The more accurate the individual EDF vectors for the risk factors and their elements, the better the lender can predict risk and profitability measures for the prospective loans.

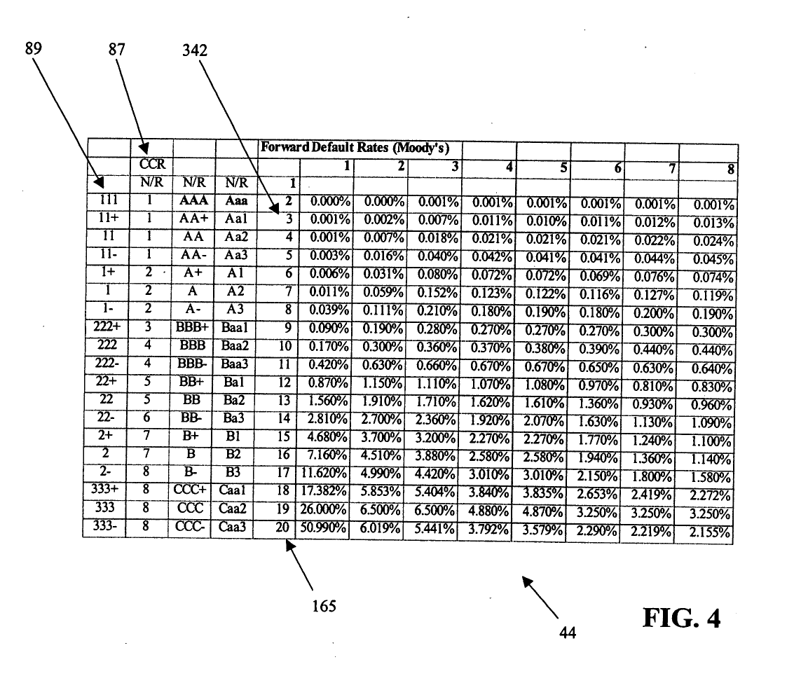

The EDF vectors for each risk factor can be obtained based upon a score or rating for each risk factor and a pre-determined table representing sets of EDF values extending over a given range of time for a given range of risk ratings. In one embodiment of the invention, the time period is 30 years and the range of risk ratings extends from 1 to 20. The risk ratings may alternatively be based on well-known risk ratings, such as Moody's or S&P's, for example. For example, FIG. 4 shows a portion of a sample EDF table 44, projecting a set of EDF values over a given period of time for a given range of risk ratings (see column identified at 165). Thus, for example, a risk factor having a rating of A3 for a given project, would have an associated EDF vector with a default frequency of 0.039% in year 1, 0.111% in year 2, and so forth, if based on the EDF table shown in FIG. 4. The risk factor score or rating is determined depending upon the input for that risk factor and the scoring system or rating scale used in connection with the present invention. The following discussion will describe how EDF vectors are determined for each risk factor.

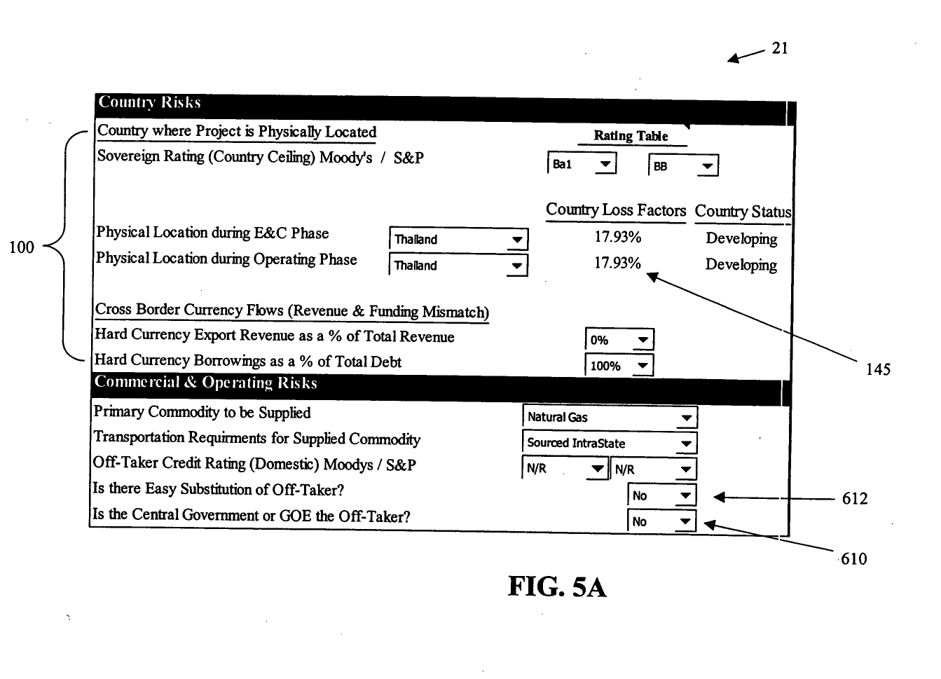

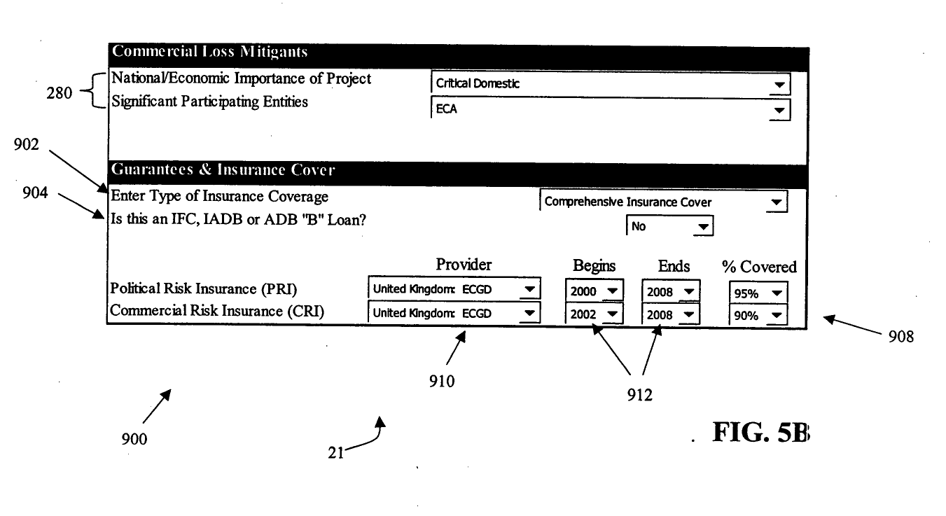

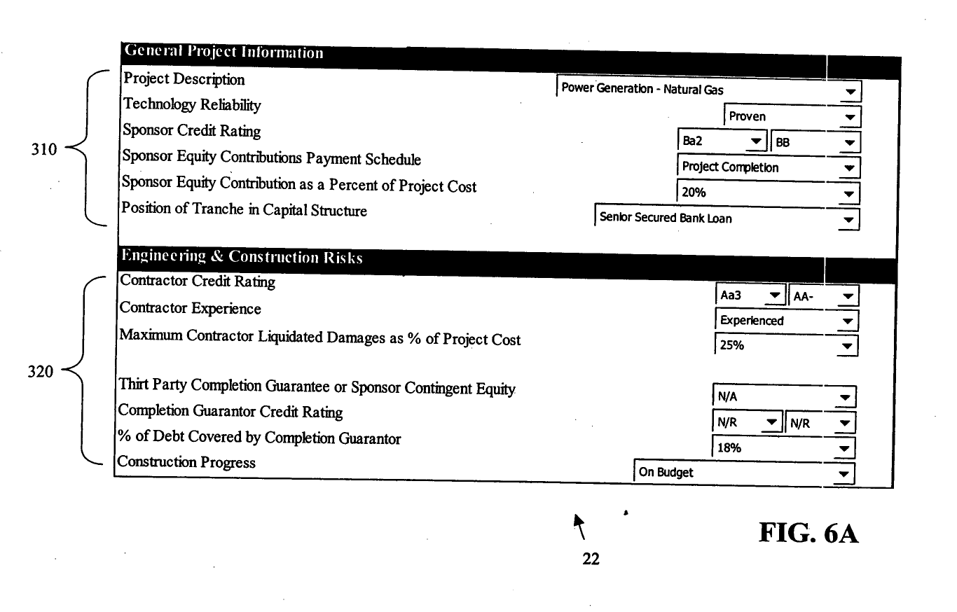

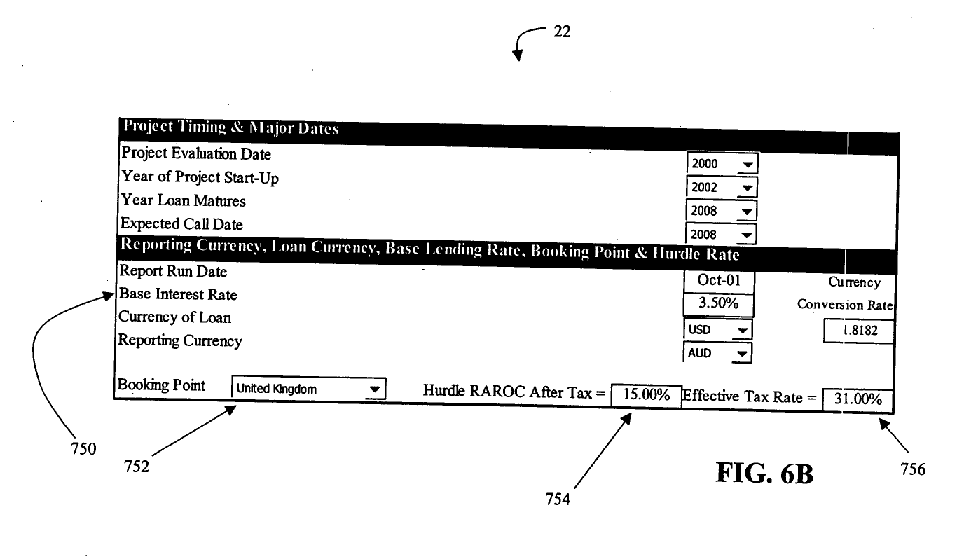

FIGS. 5A, 5B, 6A and 6C show sample input pages 21 and 22 depicting one embodiment of the various risk factors and elements which can be input into the risk model of the present invention. It will be appreciated that for some determinations, additional elements can be added while for others fewer elements are necessary. For example, the input page can include a project identification area for inputting the project name, customer name, facility identifier, project participants and other project description information. This information can include the identification of parties providing credit or economic support to the project. Other information which can be entered can be described as follows.

Country Risk Factors

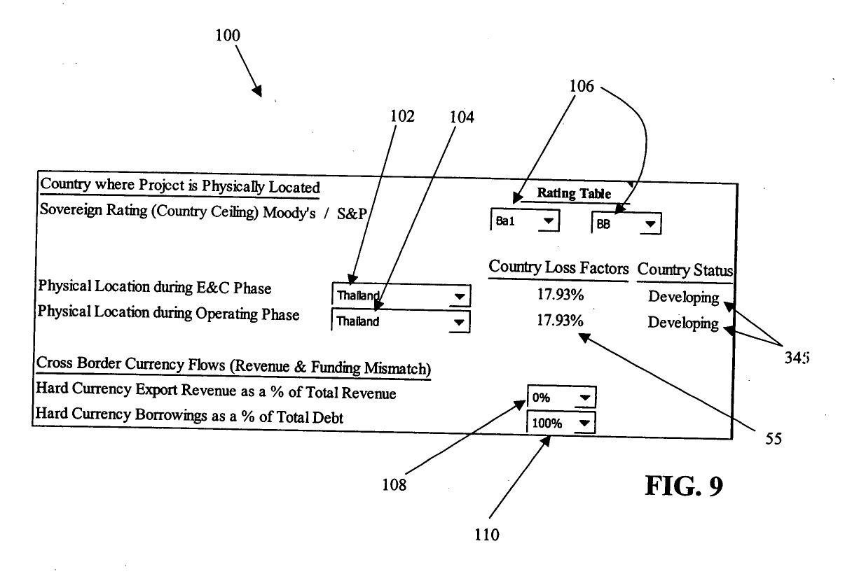

As shown in FIGS. 5A and 9, the country risks 100 can be identified and represented on the input page. As shown in FIG. 9, for each project, there can be identified the country 102 in which the project construction and engineering is taking place, and a country 104 in which the project will be operated. In many cases, the project is developed and operated in the same country. However, in some cases these locations are different, such as in the construction of a super tanker or power barge where construction takes place in a location different from where it will operate.

For a given country, a sovereign rating can be provided as at 106 as is known in the art. For example, each country can have a country ceiling rating as provided by Moody's™ or Standard & Poor's™ (S&P™). Other embodiments can incorporate ratings provided by other rating services. This rating can represent a country's willingness and ability to meet foreign currency obligations. Together with a default table, such as shown in FIG. 4, the sovereign rating can be used to estimate the country EDF.

Further, consideration as to any revenue and finding currency mismatch can assist in the country risk determination. Revenue and funding mismatch can occur when the currency in which the project receives payment (revenue) is different from the currency in which the project is funded. For the risk consideration, the system of the present invention can consider elements such as what the hard currency export revenue is as a percentage of total revenue, as at 108, and what the hard currency borrowings are as a percentage of total debt, as at 110, as shown in FIG. 9. These factors become more important in the consideration of LGD, described hereinafter.

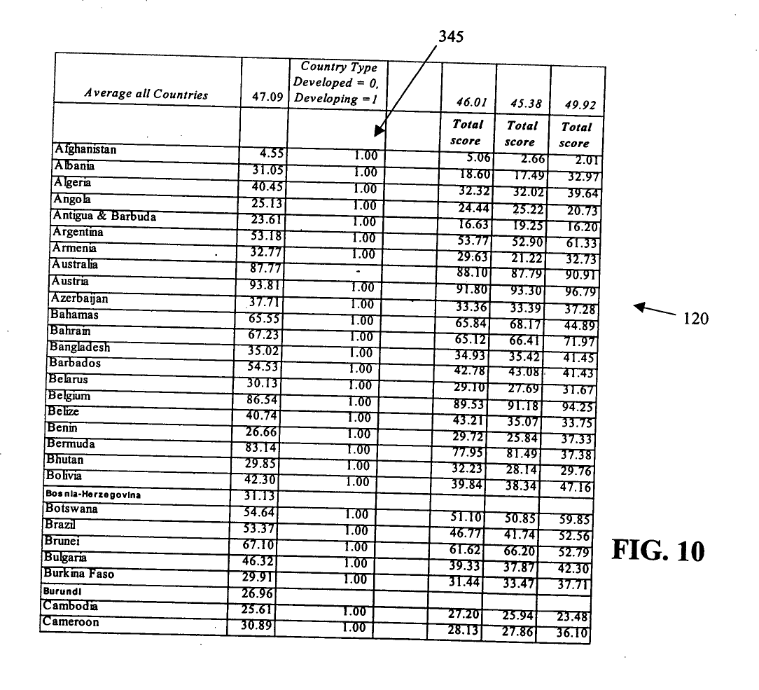

FIG. 10 is an example of a partial table 120 showing Country Risk Indices (CRI) for several countries as provided by EuroMoney Bank. In one embodiment, the Country Risk Indices are provided as EuroMoney country risk indices. In other embodiments, the Country Risk Indices can be provided by World Markets Research Center PLC, or a commercially developed proprietary index. This index can be used in a number of ways. For example, the rating can be used to split the total country default rate into its component parts, cross border (currency inconvertibility) risk and political violence (war, expropriation, regulatory instability, etc.) risk. In this table, a low rating means the fraction of country EDF attributable to political violence is high. Conversely, a high rating means the fraction of total country EDF attributable to political violence is small.

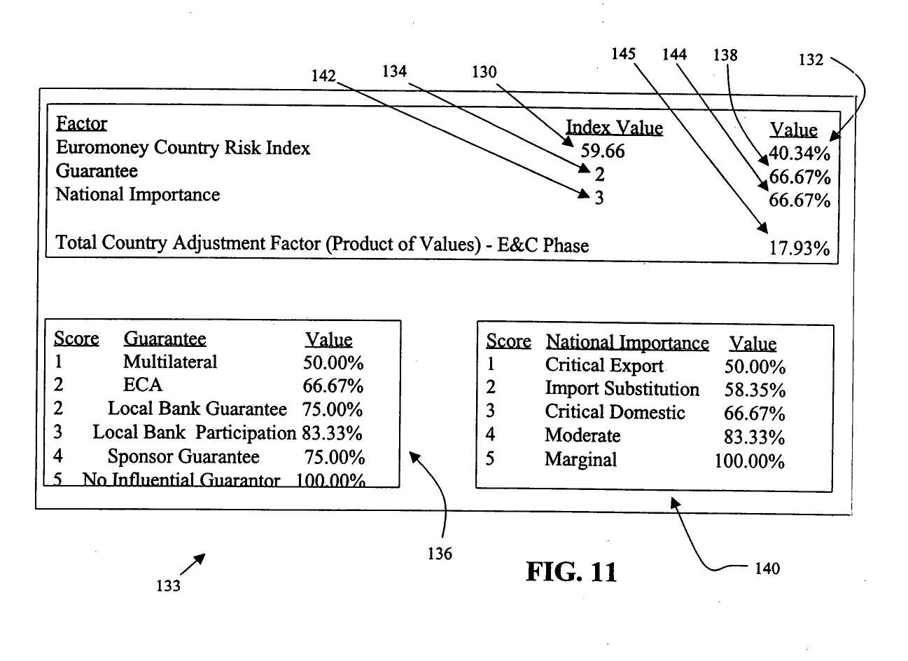

FIG. 11 provides a table 133 showing an example calculation of a country loss factor in accordance with the present invention. As an example, if the country where the project is constructed and operated is Thailand, the EuroMoney Country Risk Index or CRI taken from a table such as the one shown in FIG. 10 might be 59.66%, for example. As shown in FIG. 11, the CI is the index value 130 for Thailand, and the resulting raw country loss factor value 132 for Thailand is (100−CI) or 40.34%, in this example. The final country loss factor is determined by taking the raw country loss factor and adjusting the value obtained based on commercial loss mitigants. As shown in the tables in FIG. 11, commercial loss mitigants can include the national economic importance of the project as at 140 and the participation of significant third party guarantors as at 136. As shown in FIG. 11, the input 134 related to the guarantee indicates that an ECA is an influential guarantor for this project. This results in a score of 2 as taken from the guarantee table 136, in this example, which translates to a country loss factor value 138 of 66.67%. It can be seen that the lack of an influential guarantor (score of 5) participating in a given project means that there will be no associated reduction of risk shown in the Country Adjustment Factor. As further shown in FIG. 11, the national importance of the project in this example has been taken from the national importance table 140 representing that the project involves a critical domestic. This gives the project an index value 142 of three, and a corresponding calculation value 144 of 66.67% in this example, thereby reducing the Country Adjustment Factor by one-third. The Country Adjustment Factor 145 can then be represented on the input page, as shown at 145 in FIG. 5A, to be used by the system of the present invention in the calculation of risk and profitability measures to be described.

The input element of the present invention may optionally include a country risk element associated with political and/or regulatory stability, war, and expropriation. Standard risk evaluation can be employed so that consideration is given to the country's history of expropriation, the country's history of creeping expropriation through regulatory restriction or change in tax law, and the political stability of the country in general. Using these guidelines, in one embodiment of the invention, the user can quantitatively measure the political violence risk of the project using the sovereign credit rating and a relative ranking, such as Not Meaningful, Low, Moderate, and High, for example. Depending upon the user's input, a score can be given to the political risk element and factored into the country adjustment factor for further refinement and accuracy of results.

From these country risk factors, an EDF can be computed as part of the overall calculation of EDF for the project. The total country EDF is computed based on the sovereign credit rating of the country in question. The political violence EDF is computed by taking the product of the EDF associated with the sovereign rating and the unadjusted or raw country loss factor 132. The cross border EDF is what remains after the political violence EDF is subtracted from the total. Thus, as shown at 150 in FIG. 3A, a country having an equivalent sovereign rating of Ba1 (or a rating index of 12, taken from FIG. 4), will have an EDF vector showing an EDF of 0.870% in year 1, 1.150% in year 2, and so forth.

In one embodiment of the invention, the EDF for country risks can be determined as follows. The country sovereign rating of the country where the project will be operated is input into the system of the present invention. As previously described, the country sovereign rating can be used to project a set of EDF values for each year of the project operation. These values can be taken from Moody's ratings, S&P's ratings, another rating system, or a combination of rating systems. This set of EDF values, or this EDF vector, represents the total country EDF and may be taken from the table shown in FIG. 4, for example. In the table shown in FIG. 3A, for example, a combination of rating systems are employed, and an average 152 of the obtained EDF values is used as the EDF vector representing total country risk. The total country EDF can then be divided into a political violence EDF and a currency inconvertibility EDF.

The political violence EDF can be determined by multiplying the country sovereign rating by the raw country loss factor. If the country sovereign rating is 12, for example, and the raw country loss factor is 40.34%, for example, the political violence rating will be approximately 4.8. This number can be rounded to 5, as identified on the EDF vector table shown in FIG. 3A at 154. Applying the political violence rating to the previously established table in FIG. 4 having a set of EDF values for given ratings over a given period of time, a political violence EDF vector 156 can be determined. In one embodiment of the invention, the political violence rating can be used to obtain multiple EDF vectors, using different historical default rating tables, and an average of the obtained EDF values can be determined. The currency inconvertibility EDF vector 160 can then be determined by subtracting the EDF value associated with the political violence EDF from the EDF value associated with the total country EDF for each year having an EDF value. Thus, for example, in year one, the total country EDF may be 1.215%, for example, and the political violence EDF may be 0.003%. In this case, the currency inconvertibility EDF for year one would be 1.212%.

Commercial Risk Factors

Engineering and Construction Risk Factor

In addition to identifying and entering the country risks into the input page of FIGS. 5A and 9, commercial risk considerations can be entered. As part of the commercial risk, construction risk addresses the risk the project will not be completed within budget or that it will not perform to specifications such that the project will not be able to repay all of its debts. In one embodiment of the invention, the user can choose from construction risk labels such as Not Meaningful (such as for gas fired power plants, for example), Low (such as for modem tankers, or coal fired power plants, for example), Moderate (such as for petroleum refining, petrochemical plants, for example), and High (such as for large complex projects, including nuclear projects and projects dependent on untested technology, for example).

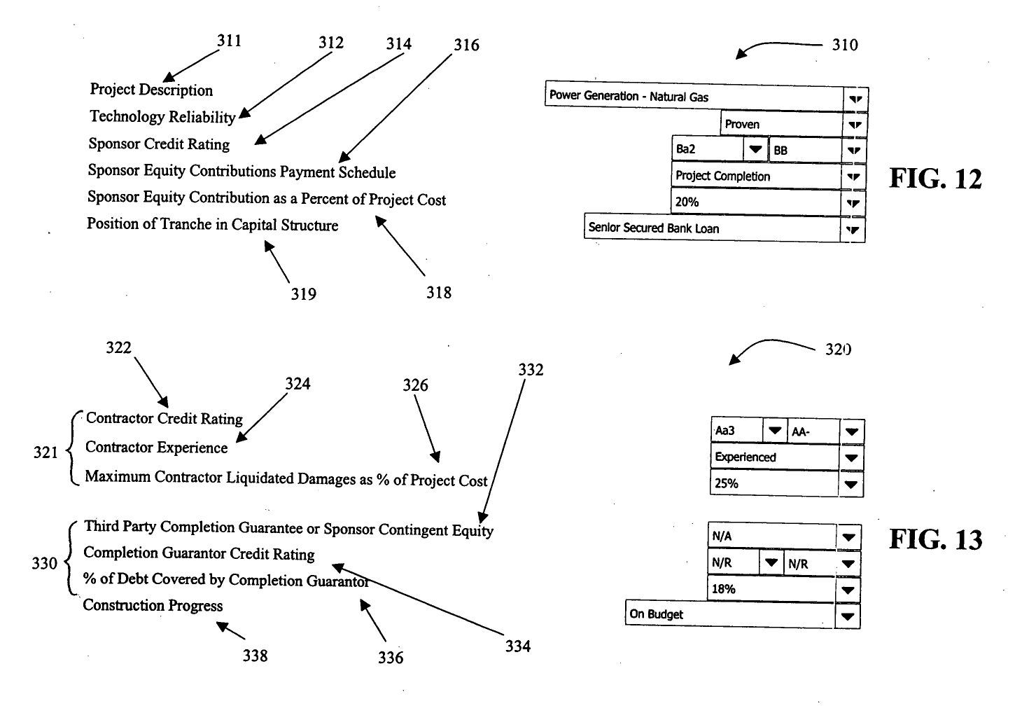

In another embodiment, historical statistics can be used where available to estimate the probability of default during the construction phase of a project given the kind of project under construction. Sponsor funding risk is part of the construction phase risk. A project can default during the construction phase because the sponsor goes bankrupt during construction and cannot deliver the funds necessary to complete construction. As shown in the table 310 in FIGS. 6A and 12, the contribution of sponsor default to the overall construction EDF is a function of the sponsor's credit rating 314 (as provided by Moody's, S&P's, or other rating system, for example), the fraction of total construction costs funded by the sponsor 318 and the timing of the sponsor construction payments 316 and the position of the tranche in the borrower's capital structure 319. The sponsor can fund the project construction 1) “up front” in which case there is no funding risk, 2) “pro-rata” over the construction period where the risk is spread over the construction period or, 3) “at completion” where funding risk is concentrated in the year of project completion. The earlier the contribution payment by the sponsor, the lower the associated risk. The sponsor's equity contribution can range from 0% to 100%. As further shown in FIG. 12, the project type 311 and technology employed 312 further factor into the determination of the probability of default within the engineering and construction phase.

In another embodiment of the invention, as shown in FIG. 13, the system can consider contractor information 321, third party completion guarantee information 330, and construction progress 338 as part of the construction risk elements in table 320. Contractor information 321 can include the engineering and construction contractor's credit rating 322 (as can be represented by a Moody's or S&P rating), the contractor's experience 324, and the maximum contractor liquidated damages as a percentage of the project cost 326. The contractor's experience can be rated as experienced, not experienced, or not applicable. The contractor liquidated damages figure can be represented anywhere from 0% to 100%.

Third party completion guarantees 330 reduce the probability of default caused by a construction failure. If the project benefits from a third party completion guarantee, this is acknowledged as at 332. In one embodiment of the invention, the completion guarantee input element can include input for the existence of sponsor contingent equity, such as where the project sponsor provides an equity investment in the project in the event of a cost overrun and thereby reduces the probability of default. In one embodiment of the present invention, the third party completion guarantee or sponsor contingent equity can be represented as either existent or not applicable. Also, the system can accept as input the completion guarantor credit rating (CCR) 334 (as represented by Moody's™ or S&P™, for example) of the guaranteeing party as well as the percentage of debt covered by the completion guarantee 336. In one embodiment of the present invention, the input range for the percentage of debt covered 336 can range from 0% to 100%.

The construction progress 338 can also be considered in the risk analysis of the present invention and, in one embodiment, can be input as on budget, ahead of budget, or behind budget with an appropriate percentage ahead or behind. The progress of construction can play a significant role in the determination of loan risk and profitability measures.

It will be appreciated that the pre-determined input options as shown and described herein are presented as options, and additional or fewer relevant input options may be presented to the user as desired and as determined to be proper for promoting the optimal accuracy of calculations and determinations by the present invention.

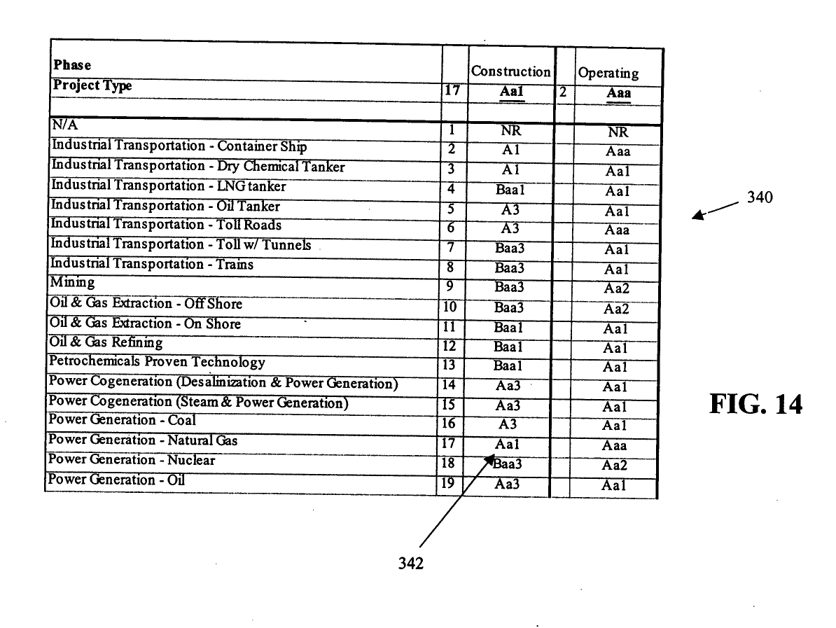

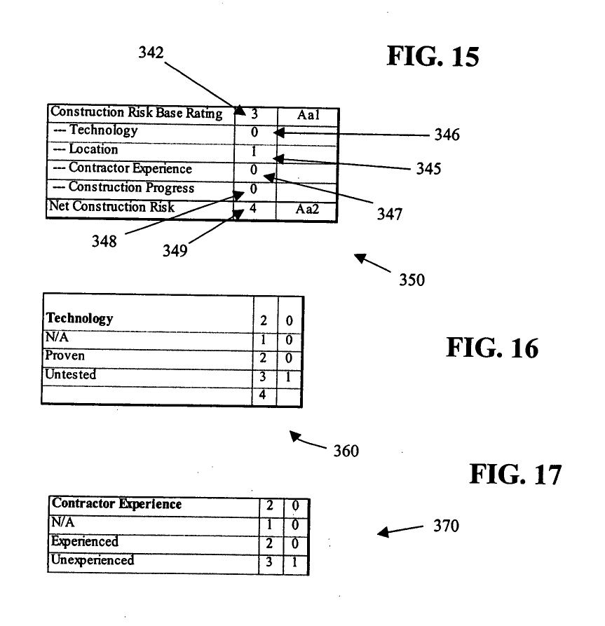

Once these inputs are received by the system of the present invention, they can be used to determine a score, as well as a rating, which will determine an EDF vector for the engineering and construction risk factor. This vector can then be used in the overall determination of a commercial EDF for a given prospective loan. As an example, a construction risk base rating can first be determined based upon the project type 311. For example, if the project is related to natural gas power generation, it may be determined to have a base construction phase score of 6. A scoring table 340 such as shown in FIG. 14 can be used in determining a set of base construction phase scores for various project types. The score is an indication of where in the table of EDF vectors (FIG. 4, for example) a particular risk factor will fall. Generally, the higher the score, the greater the risk, and thus the greater the EDF values within the determined EDF vector. In the present example, the construction is performed for a natural gas power plant, which is shown to have a construction phase risk rating equivalent to a Moody's Aa1 rating, as indicated at 342 in FIG. 14. This Aa1 rating can be based on historical information or on a proprietary rating system developed in connection with the invention. Once the rating of Aa1 is obtained, the equivalent rating score can be obtained by referring to the EDF table shown in FIG. 4, as at 342. This rating is 3, and can then be transferred to a calculation table 344, as shown in FIG. 15, to be used in determining the appropriate EDF vector to use for the construction risk factor.

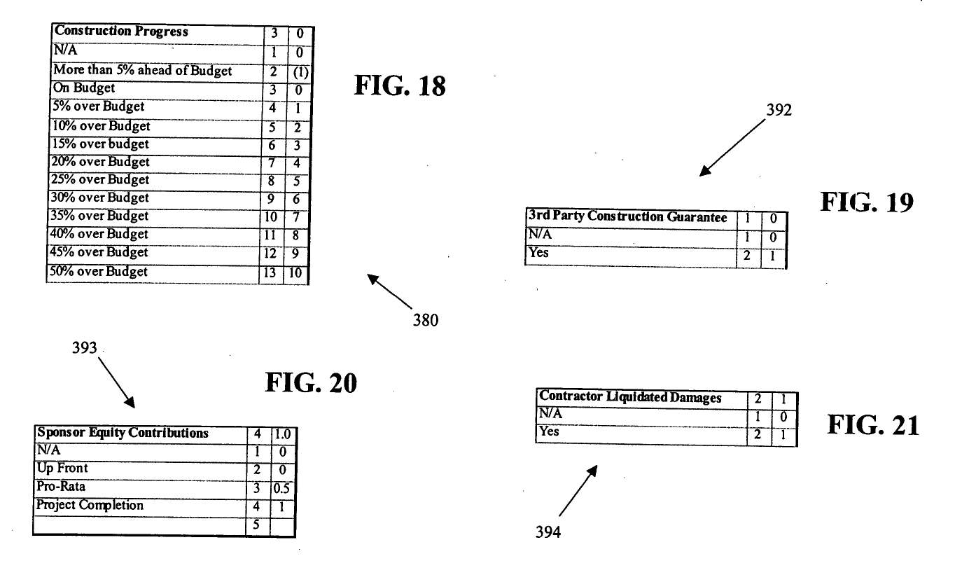

Within the construction risk factor, additional points can be added to the base construction phase score based on the inputs previously described, as shown in FIG. 15. For example, if the country in which the project construction is taking place is a developing country, an additional point can be added as at 345 in FIG. 15 to yield a temporary score of 4 for the construction phase. If the country of project construction is developed, no additional point would be added in this embodiment of the present invention. Whether a country is a developing country can be determined by consulting the country risk indicator table in the column designated 345 as shown in FIG. 10. This element can also be represented on the input page of FIG. 9 as at 345. If the technology of the project is proven, no additional point would be added, as at 346; however, if the project technology is unproven, an additional point would be added, as determined by the project technology table 360 as shown in FIG. 16. In this example, the project technology is proven as taken from input 312 in FIG. 12, so the temporary construction risk factor score is still 4. If the contractor is determined to be experienced, no additional point would be added, as at 347; however, if the contractor is inexperienced, an additional point would be added in this embodiment of the present invention, as determined by the project technology table 370 as shown in FIG. 17. In the present example, no additional point would be added since the contractor is determined to be experienced, and thus the temporary construction risk factor score is still 4. Depending upon the progress of the construction, additional points can be added as shown in FIG. 15 at 348. In the present example, the construction progress is determined to be on budget, and thus an additional point is added to the construction risk factor score, giving a total score of four for this factor. A sample table 380 showing the construction progress elements and corresponding scores is shown in FIG. 18. The total score 349 then corresponds to a respective set of EDF values for a given risk rating. In the present example, the Moody's equivalent risk rating is Aa2, as shown at 350 in FIG. 12. The risk score and the Moody's equivalent rating correspond to an EDF vector from the table of vectors provided in FIG. 4. This EDF vector is considered the initial Net Construction Risk and can be shown in the EDF vector table of FIG. 3A at 390.

This vector can be adjusted based upon the inputs described relating to the sponsor's credit rating 314, the sponsor's equity contribution method 316 and percentage 318, the position of the tranche within the borrower's capital structure 319, the contractor's credit rating 322, the presence or absence of a completion guarantor 332 and their credit rating if present 334, the maximum contractor liquidated damages as a percentage of project cost 326, and the percentage of debt covered by the completion guarantor 336. Scores and ratings for each of the above elements can be obtained by consulting an appropriate scoring table and corresponding EDF vector. A sample completion guarantee scoring table 392 is shown in FIG. 19, a sample sponsor equity contribution scoring table 393 is shown in FIG. 20, and a sample liquidated damages scoring table 394 is shown in FIG. 21. For example, the funding risk given the sponsor funding method would use the score for the type of funding provided by the sponsor as shown in FIG. 20 (in this case, 1.0) and multiply that score by the average EDF vector rating for the sponsor. The funding method score can be 0, 0.5, or 1.0 depending upon whether the sponsor's equity contribution is up-front, pro-rata, or at completion.

In one embodiment of the present invention, the final net construction risk is determined by summing the following values: (a) the initial net construction risk multiplied by (1−the liquidated damages percentage) multiplied by (1−the percentage of debt covered by the completion guarantor); (b) the contractor default rate (which may be an average of available rates based on the contractor's credit rating) multiplied by the percentage of contractor liquidated damages, multiplied by (1−the percentage of debt covered by the completion guarantor); (c) the completion guarantor default rate (which may be an average of available rates based on the completion guarantor's credit rating) multiplied by the percentage of debt covered by the completion guarantor; and (d) the funding risk percentage given the finding method multiplied by the percentage of construction risk before guarantees. The final net construction risk thus represents a set of EDF values over a given period of time, or the final net construction risk EDF vector, shown at 396 in FIG. 3B.

The final net construction risk EDF vector may or may not be used in determining the total commercial risk EDF vector, depending upon whether the project has already begun operating. For example, if the project is already begun production, the construction risk is zero, because the construction is already complete and there is no risk that construction will not be completed.

Technical Operating Risk Elements

Another element of commercial risk considered by the present invention is operating risk. This element addresses, for example, the risk that the plant operates as designed, project operators mismanage plant operations or forgo required maintenance and further addresses the level of technical difficulty in operating the plant. It can also address the risk present due to the variations in grade of the resulting product (e.g., an oil refinery in California may produce a tar-like oil product while one in Saudi Arabia might produce a smooth oil product—thus, the California refinery would be less efficient as it may require re-processing of the oil product.) The operating risk element further includes the potential for operating cost overruns that impair the plant's ability to service its debt.

Elements considered within operating risk factors include the type of project for which financing is sought, as indicated at 311 in FIG. 12. For example, the project may be an industrial transportation project (such as an LNG tanker), an oil and gas extraction project, or a power generation project using natural gas as an energy source. Many types of projects can be considered and each can have a different impact on the determination of the loan analysis. The technology used and whether it is proven or untested can also be input as at 312 into the decision analysis.

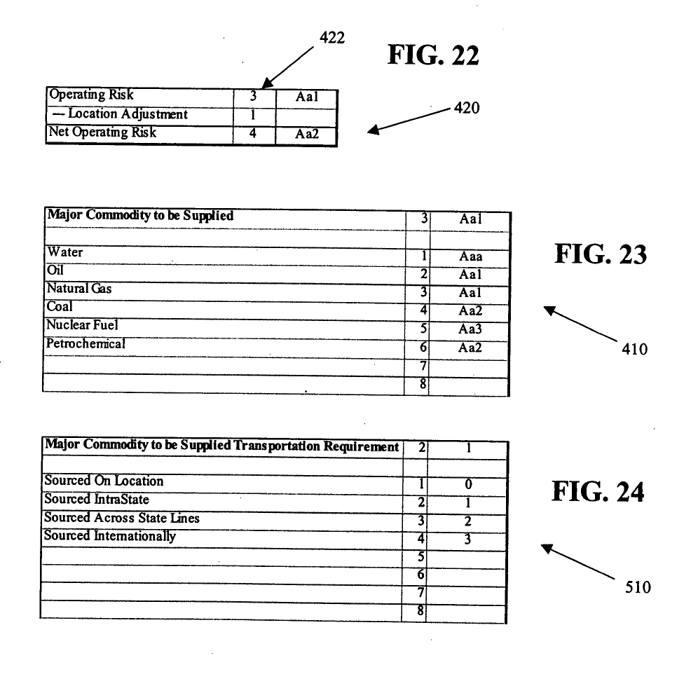

In computing the operating risk EDF vector, if natural gas is the technology used to generate electricity, for example, the system of the present invention first determines a score by finding power generation-natural gas on the supplied commodity table 410, as shown in FIG. 23. This score corresponds to a rating on the EDF vector table in FIG. 4, which can be recorded as at 422 in the operating risk scoring table 420 of FIG. 22. The score or rating 422 provided for technical operating risk can be adjusted based upon the location of the project, as further shown in the scoring table 420 of FIG. 22. For example, if the country is a developing country, as discussed previously, a point may be added to the operating risk factor score. The total score 424 can then be correlated to a risk rating for which there is a corresponding EDF vector, as taken from the table shown in FIG. 4. This vector 430 is the net operating risk vector, and can be represented on an EDF vector table as shown in FIG. 3B.

Supply/Supplier Risk

With regard to further specifics of the operation of the project, as shown in table 410 in FIG. 23, the system of the present invention can consider the primary commodity to be supplied as part of a separate commercial risk element factor related to supplier risk. This commodity can be, for example, water, oil, natural gas, coal, or a petrochemical. The system of the present invention can also include for consideration the transportation requirements for the supplied commodity, which may be sourced on location, sourced intra-state, sourced across state lines, and/or sourced internationally. The transportation requirements scoring table 510 can appear as shown in FIG. 24. In general, the easier the transport and closer the supply of the commodity, the lower the associated risk.

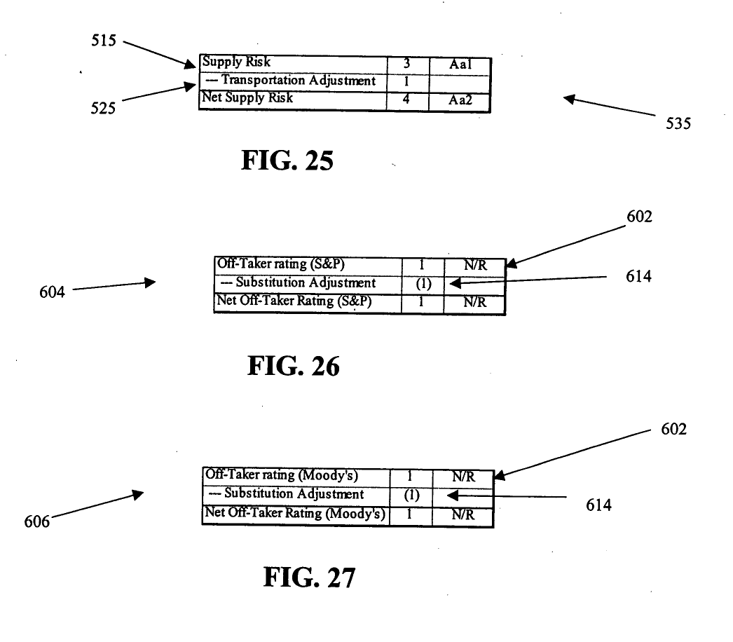

In computing the supply/supplier risk EDF vector, if natural gas is the commodity used, for example, the system of the present invention first determines a score by finding natural gas on the commodity to be supplied, as shown in FIG. 23. The score or rating provided for supply/supplier risk 515 can be adjusted based upon the transportation adjustment factor score 525 discussed above, as shown in FIG. 25. commodity to be supplied. The net supply risk score 535 can then be correlated to a risk rating for which there is a corresponding EDF vector, as taken from the table shown in FIG. 4. This vector 545 is the net supplier risk vector, and can be represented on an EDF vector table as shown in FIG. 3B.

Off-Taker Risk

An additional risk element considered by the present invention can include the off-taker's credit rating 602, which can be used in scoring tables 604, 606 as shown in FIGS. 26 and 27. For projects having an off-taker, or customer, the input page (FIG. 5) allows the user to indicate whether the off-taker is the central host government, or is owned by the central host government as at 610. An off-taker that is a private company will have a different estimated LGD than that of a government off-taker. In a developed economy, it is often desirable to have a private commercial off-taker as opposed to a government as it is easier to replace a private off-taker for non-performance than it is to replace the local host government as the off-taker. In one embodiment of the present invention, regional governments can be treated as private enterprises. The lack or presence of an easy substitute off-taker can also be considered as at 612 by the present invention in the overall risk assessment.

In determining the Off Taker risk EDF vector, the present invention can use one or more EDF vectors taken based on the Off Taker's credit rating. The Off Taker's local currency credit rating may be adjusted based on the presence of an easy substitute off-taker and can be scored as shown in the tables 604, 606 of FIGS. 26 and 27, respectively. The Off Taker score may also be adjusted based on whether the government is the off taker and whether there is an easy substitute of an off-taker. For example, if the government is not the principal off-taker, a point can be subtracted from the score established initially by the off-taker credit rating to reflect the fact that operating default rates are less than financial default rates. Further, if the off-taker can be substituted with ease, a point can be subtracted to the off-taker risk score. If there is an easy substitute, a point may be subtracted to reflect the reduced risk, such as shown at 614 in FIGS. 26 and 27. As described with previous risk factors, the off-taker risk factor EDF vector can be taken from the table of EDF vectors as shown by way of example in FIG. 4, and can be added to the EDF vector table shown by way of example in FIG. 3B at 620.

Refinance Risk

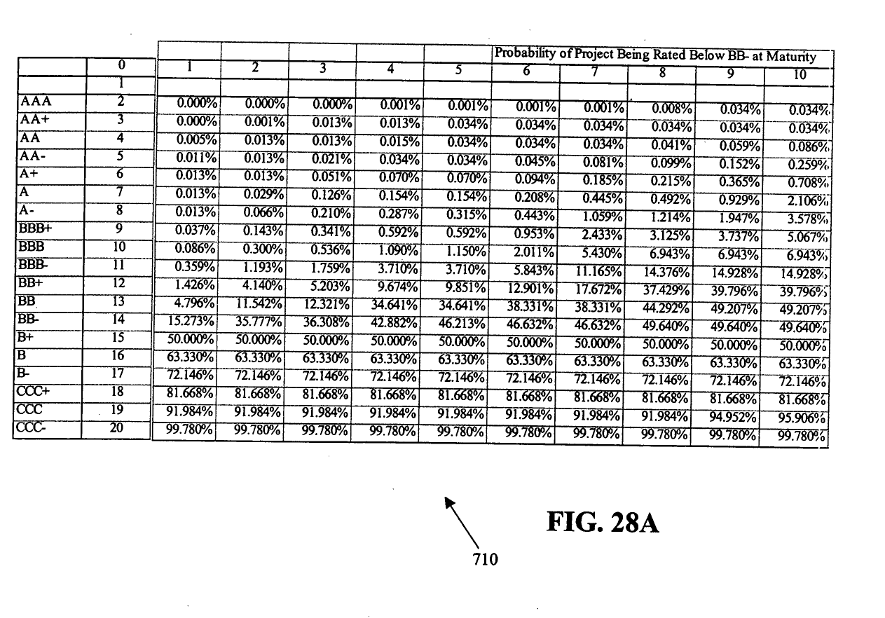

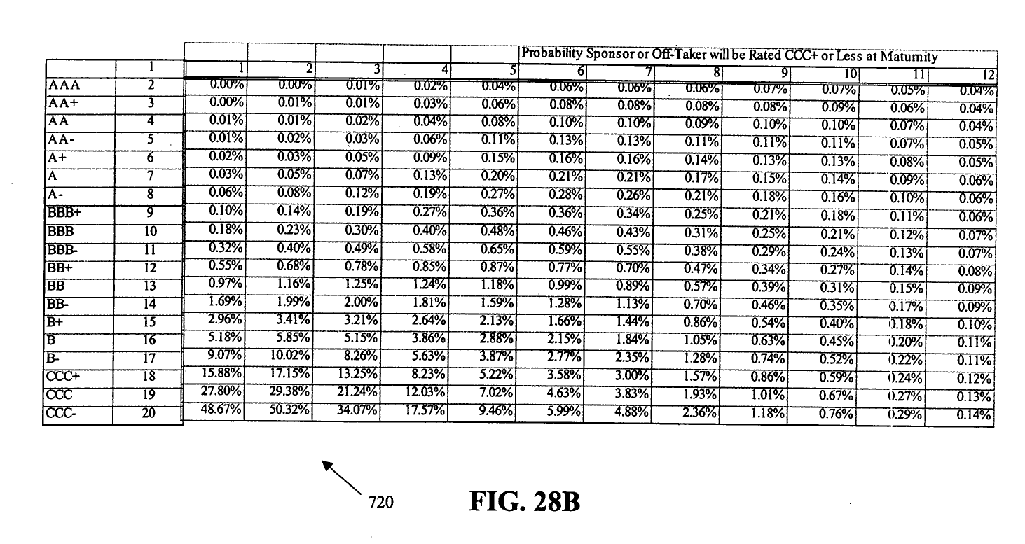

The structure of some loans is arranged such that the loan matures within five to seven years, and thus the vast majority of the principal is due at the time of maturity. Knowing this large balloon payment is coming due, most companies will begin the process of refinancing far in advance of the actual loan maturity date. There are generally two ways a project can be refinanced—(1) at the project level, where the project is refinanced on a non-recourse basis and remains an independent project or (2) at the parent company level, where the project is refinanced at the corporate level and the asset folded into the corporation. At the project level, a project can generally get financing if it is rated at a certain level or higher. As an example, this hurdle level can be a BB rating under the Moody's rating system. At the parent company level, a generic corporate borrower can generally get financing if it is rated B or higher, under a Moody's rating system for example. The present invention considers this refinancing risk by estimating two factors on the day of the balloon payment. First, the present invention estimates the probability the parent corporation will be rated CCC or lower and neither the project nor the sponsor has defaulted. In one embodiment of the present invention, rating migration matrices are employed to provide this estimation. As shown in FIGS. 28A and 28B, sample rating migration matrices 710, 720 provides historic probability estimates that a corporation having a given rating will be rated at CCC or lower over time. Second, the present invention estimates the probability the project is rated B or lower and has not defaulted. The RIM model of the present invention estimates the rating of a project each year in the future, based on its expected default rate. Through statistical analysis, the likelihood the default rate is higher than what is estimated can be estimated. With this information, the system of the present invention can estimate the likelihood the project will have a lower rating in the future than what is originally expected, without having reached the point of default. A sample table 710 representing these EDF values is shown in FIG. 28A.

If the project has an off taker, the credit rating of the off taker drives the credit rating of the project. In this case, the method of estimating the off taker's future rating being B or below (but not defaulted) is derived from the rating migration method.

Once the EDF vectors have been obtained for the various refinance scenarios, the lowest EDF vector can be used in the determination of overall commercial factor EDF. The lowest EDF vector is selected because, since the corporate sponsor has multiple options for refinancing, the probability of refinancing failure is the lowest of the probabilities determined.

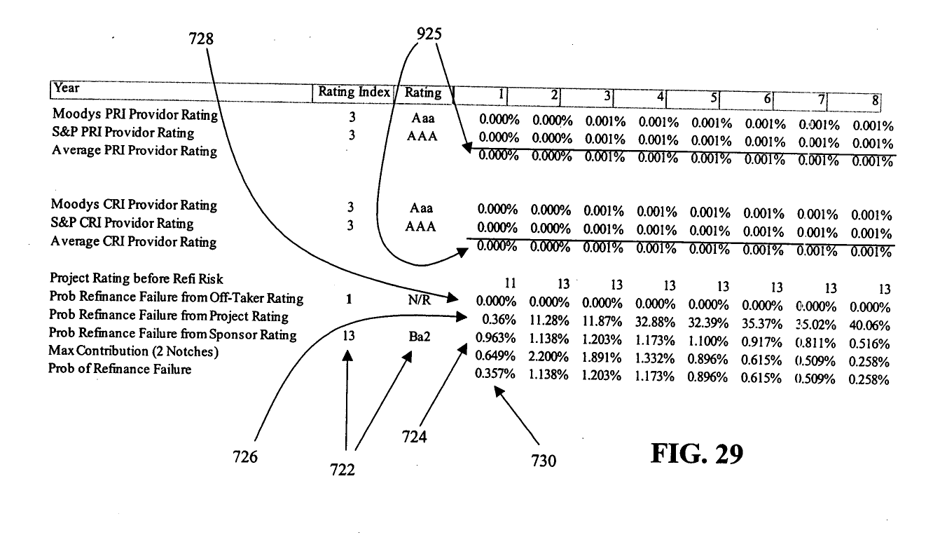

As an example, if a sponsor corporation has a credit rating of Caa1, or rating index value of 13, as shown in FIG. 29 at 722, the EDF vector 724 for sponsor refinance risk can be taken from the corresponding rating from the historical rating migration matrix 720 shown in FIG. 28B. The EDF vector for project 726 and off-taker 728 refinance risk can be determined in a similar way by referring to the sample tables shown in FIGS. 28A and 28B. Since the corporate sponsor has multiple options for refinancing, the total refinancing risk is the lowest of the EDF vectors obtained, as shown in FIG. 29 at 730, for example. If there is no off-taker, the total refinancing risk is the lower of the EDF vectors between the project refinancing risk and the sponsor refinancing risk.

Base Lending Rate, Booking Point, Hurdle Rate & Tax Rate

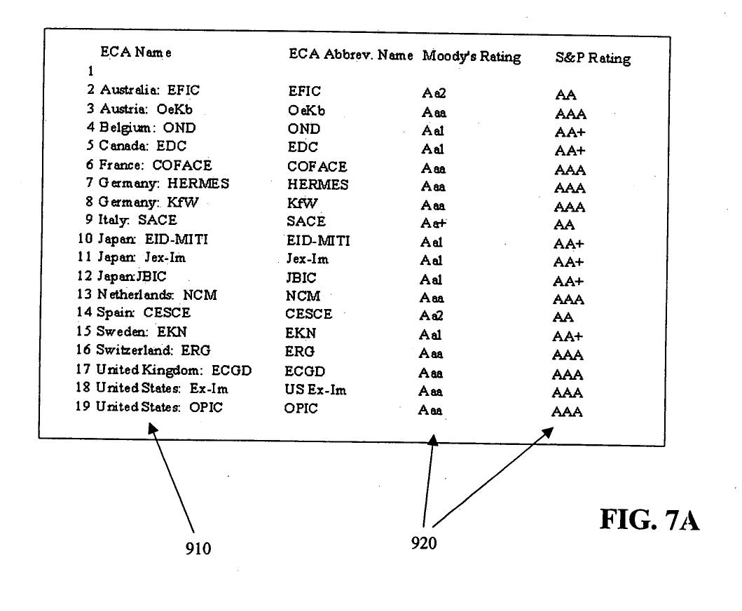

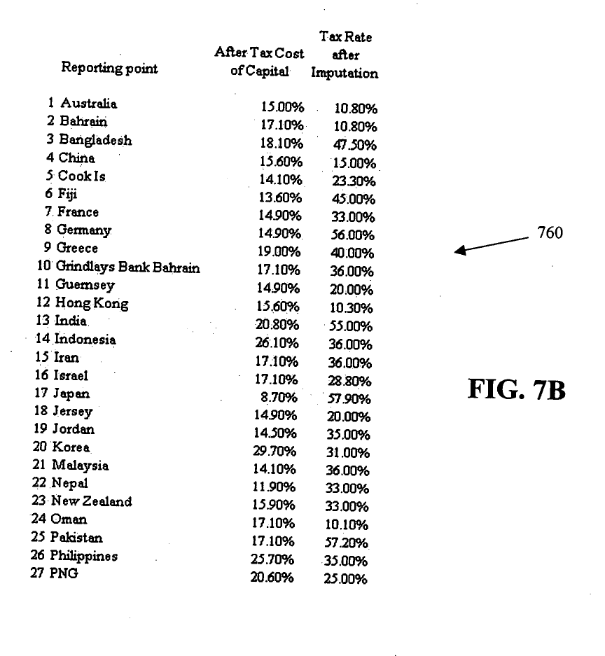

As shown in the table 22 in FIG. 6B, the present invention can receive inputs related to the base lending rate 750 and the booking point 752. The base interest rate 750 is the benchmark rate to which the loan margin is added. In most cases, this is LIBOR (London Interbank Offered Rate) or the bank bill rate. The booking point 382 defines the after tax hurdle rate 754 and the effective tax rate 756, which are key components in the NIACC computation. As shown in FIG. 7B, this information can be provided in a table 760.

Macro Economic Risk

The present invention also considers the additional commercial risk factor related to macro-economic elements which can affect the financial performance of the project. This can include a fluctuating market price of commodities, interest rates, foreign exchange rates, a fall in the demand of project off-take, or a rise in the price of project inputs, for example. The most potent risk mitigant in a project loan is a strong economic under-pinning. Contracts cannot remove risk, only shift it to participants who are better able to manage or tolerate it. There will be an economic incentive for contracts to be broken, if the terms of the contract become uneconomic by the disadvantaged party.

In one embodiment of the present invention, the risks and loss estimates due to the movements of macro-economic factors are computed in a Monte Carlo analysis of the project's cash flows separate from the Risk Integration Model of the present invention. A Monte Carlo analysis is a specific type of modeling simulation which samples from thousands of scenarios randomly chosen which are consistent with the historical behavior of the economic variable in question to help predict how a system will behave over time. The Monte Carlo analysis is intended to quantify how robust the project economics are. One of the powerful advantages of the technique is that it can uncover potential problems or risk concentrations. As a result, it can provide some insight on project structures that minimize that risk.

The principal considerations in the Macro Economic analysis are the factors which have a significant impact on the free cash flow of the project. Free cash flow provides insight into the project's debt carrying capacity. An increase in interest rates on variable rate debt, for example, will hinder a project's ability to service that debt. Sensitivity analysis can be used to test the outer limits of a project's economic viability, (i.e. testing the cash flows to determine what level of Interest Rates, F/X Rates, Sales Volumes, etc. causes the default). While this analysis is very powerful, it has limitations. It does not reveal information about the probability of these events occurring. As used in the present invention, Monte Carlo Analysis examines all potential scenarios that a project is likely to face, weighted by their likelihood of occurring.

In accordance with the present invention, the cash flow model is stressed with the random scenarios generated to determine the likelihood that the debt of the project cannot be serviced. If a default scenario is found, a default is tallied in the year of default. The LGD is estimated by examining the free cash flow of the project cash flows given the stressed scenario from the point of default onward. The present value of those cash flows are computed using a distressed debt discount rate. This value is reduced further by the country LGD derived from the country risk index described earlier (as an estimate of the cost of recovery, the cost of interference by local government and/or the degree to which an independent judicial system and bankruptcy law exists). The value of the net cash flows is compared to the debt outstanding. If the value of the cash flows is less that the value of debt, the LGD is recorded as a percentage of debt outstanding.

Modeling the Input Variables & Macro Economic Factors

The modeling of input variables and macro economic factors is well known in connection with Monte Carlo analysis. Commodity prices, f/x rates, interest and inflation rates, etc. are modeled using a modification to the traditional stochastic process used to model economic variables which follow the efficient market hypothesis. This process is called a “mean-reverting” process. In a mean reverting process, prices in the short term are unpredictable, but over long periods of time, tend to drift toward some equilibrium level consistent with the cost of production.

Parametric Factors for Model Input

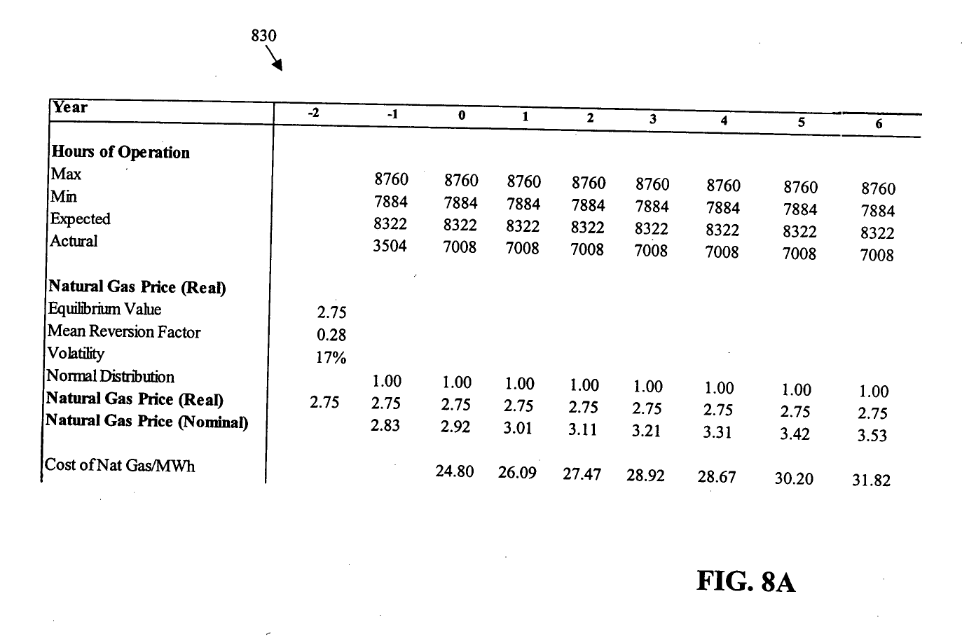

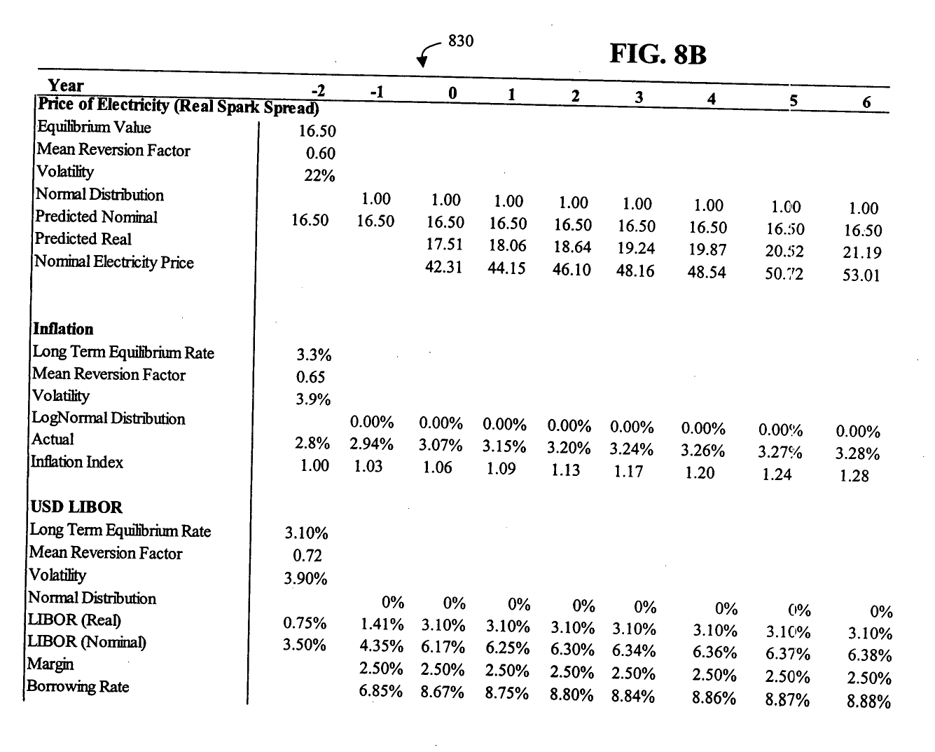

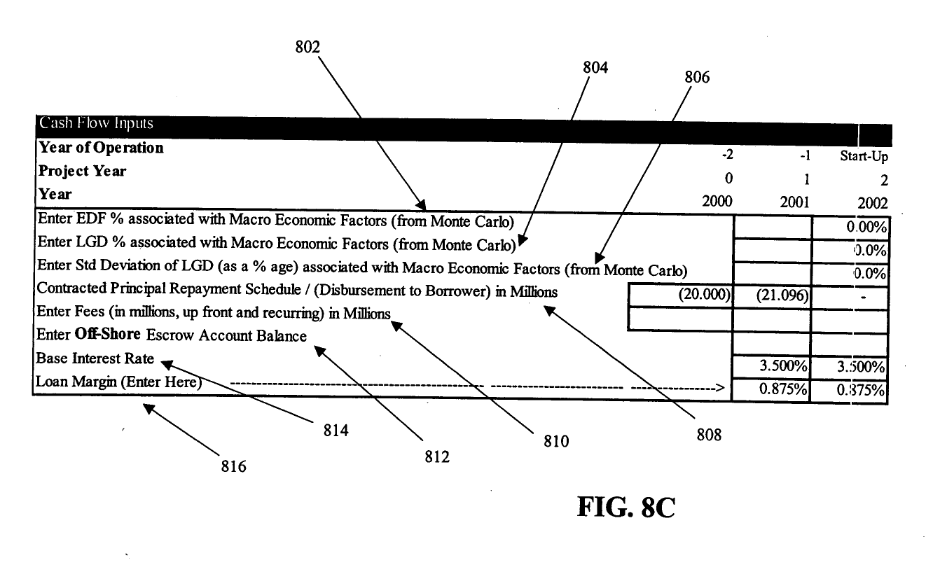

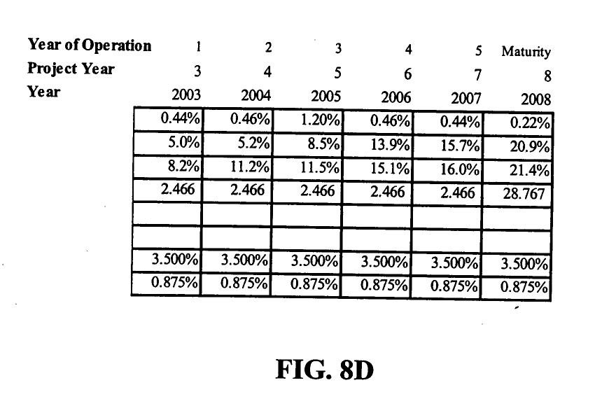

Modeling a Macro Economic Factor requires the definition and calibration of a number of parameters. Those factors first include the probability distribution, which in one embodiment of the invention can be defined as either normal or log-normal. In another embodiment of the invention, such as for off-take volumes, for example, a triangle distribution can be employed. The second factor is the current market price of the variable. The third factor is the long term equlibrium value, or the price the commodity is likely to gravitate to in the long run. This factor can be an estimate from an established authority or from historical data. Also considered is the volatility estimate, or the uncertainty of future prices. This factor can also be determined by an established authority or from historical data. The rate of mean reversion, or the rate at which the current price will trend toward the long run price, is also considered, and in one embodiment of the invention, a 10-year rate of mean can be established statistically, or by counting the number of times the historical price has passed through the long run value divided by the number of years (or time periods) examined. Lastly the correlation, or the extent to which two variables move together or in opposite directions, is considered. FIGS. 8A and 8B show one embodiment of an input page 830 which can be used in accordance with the present invention to determine a default probability associated with macro-economic factor risk.

One embodiment of the present invention incorporates an analysis based on equal time intervals, generally annual time periods. In another embodiment, an analysis is conducted over unequal time intervals. The data collected from the Monte Carlo analysis is unique to the project, and includes an EDF, LGD and a Standard Deviation of LGD which will differ for each given time period, year by year. As shown in FIGS. 8C and 8D, EDF is the Annual Expected Default Frequency as indicated at 802, LGD is the Loss Given Default as indicated at 804, and Standard Deviation of LGD is the variability of LGD, as indicated at 806. The draw down schedule and the amortizing schedule for the loan tranche being analyzed can be entered as at 808. In one embodiment of the invention, drawdowns are entered as negative numbers and principal repayments are entered as positive figures. The drawn amount can be based on the final hold estimate. With regard to fees, as indicated at 810, origination, commitment and agency fees have a substantial impact on net income after cost of capital (NIACC) and risk-adjusted return on capital (RAROC). In one embodiment of the invention, when considering the re-rating of a project, the pro-rata amount (based on exposure) of origination fees can be entered. In this way, fees may be properly included as the loan ages. With regard to offshore escrow accounts, as indicated at 812, the value of the escrow account can be considered, for example, if the terms of the contract call for an offshore escrow account and funding for this account comes from outside the country. An offshore account is a loss mitigant if currency default occurs. For it to be effective, the source of funds must be out of reach of the local government and held overseas so that they cannot be subject to local government interference. As shown at 814 and 816, respectively, the base interest rate and the loan margin are also included. Since the loan margin generally changes over the life of the loan, it must be input on an annual basis. In one embodiment of the invention, for a project having debt tranches with different maturity dates, insurance coverage, loan margins, and the like, a separate RIM analysis can be performed for each tranche.

Cash Flow Modeling & Crystal Ball™

Crystal Ball™ is an add-on application, commercially available from Decisioneering, Inc. of Denver, Colo., which can be overlaid on to a spreadsheet, such as a Microsoft™ Excel™ spreadsheet, for example, for use with the present invention. Within Crystal Ball, a user can define what variables are to be stochastically generated. The user can control the distribution, the mean, the variance and the correlation. In one embodiment, an add-on application such as Crystal Ball™ is used to conduct the Monte Carlo analysis.

Computing EDF

Using the Monte Carlo analysis, the EDF of the project can be determined in any year during the life of the project, given its financial structures (i.e. contractual arrangements, hedges, reserve accounts, etc.). This is possible because of the known probability distribution and the parameters (current price, long-term equilibrium price, variance, and rate of mean reversion) that describe the behavior of the exogenous macro economic variables. The probability distribution is applied to all the exogenous economic variables and run through the cash flow model. EDF is computed with the following formula:
EDF=Number of Defaulting Scenarios/Total Number of Scenarios.

Once an EDF vector is obtained for the macro-economic factors, consideration of types and percentages of insurance coverage can help determine a cumulative EDF value for the entire project loan.

Guarantees and Insurance Coverage

With regard to guarantees and insurance coverage, professionals involved in structured finance lending often purchase political risk insurance (PRI), commercial risk insurance (CRI) or comprehensive risk insurance (PRI & CRI) to limit exposure to risk inherent in emerging market lending. A project with no risk insurance can be called “clean” or uncovered. Such guarantees are usually provided by export credit agencies (ECAs) which are government owned enterprises (GOEs) whose charter is to promote the export of products manufactured by domestic companies. However, guarantees provided by private entities are becoming increasingly common.

PRI can help limit the exposure to cross border defaults, including the inability or unwillingness of the host government to provide hard currency (through its central bank). PRI can also help limit the exposure to expropriation, or the possibility the host government will nationalize the business, either directly or through regulation (i.e. political violence). Further, PRI can help limit the exposure due to war, wherein the project is unable to service its debt due to war or other political disruptions (also referred to as Political Violence). In general, for lenders to benefit from PRI due to the lack of available foreign exchange reserves by the local central bank, the project must be able to generate local currency (that is it must not be in commercial default). In the preferred method, the PRI insurer accepts the local currency and pays the lenders in the appropriate currency.

In some cases, PRI can be structured to cover off-taker performance, if the off-taker is a government entity. Properly structured, the PRI can be used to ensure the GOE adheres to the terms and conditions of the off-take contract. In such a circumstance, non-performance can be claimed against the expropriation clause of the PRI contract. This type of guarantee is referred to as Extended PRI or a Partial Risk Guarantee, and is a choice in the model of the present invention.

CRI can help limit exposure to defaults caused by operating failure, supply or supplier disruptions, and off-taker default, as well as defaults caused by macro-economic factors such as a loss of sales volume, drop in price, spike in interest rates, etc. In general, the provider of CRI will present local currency to the project or central bank of the host country for conversion to the appropriate currency. If the host government cannot or will not provide hard currency, lenders are stuck with payment in the currency the project has to offer.

Comprehensive insurance, as the name implies, covers all risks. The commercial component of comprehensive insurance generally does not start until construction is complete. As a result construction risks are generally not covered. Guarantees from the contractor or guarantees purchased from a private third party generally cover construction risk.

As shown generally at 900 in the table 21 of FIG. 5B, the present invention accommodates consideration of the type of guarantor and the type of insurance. The type of insurance can be entered as at 902. In one embodiment of the invention, the selection can be Comprehensive, PRI, CRI, or Clean. “Clean” means that no insurance or guarantees have been provided. The system can also accept as input whether the loan is part of a “B” loan program, as at 904. In this regard, the International Finance Corporation (IFC—the World Bank's private lending arm), the Inter-American Development Bank (IDB) and the Asian Development Bank (ADB) promote “B” loan programs. The lender of record for “B” loans is the sponsoring Multilateral Agency giving the loans preferred lender status. Historically, lenders have never suffered losses for cross border reasons. They have, however, suffered losses for commercial reasons. As a result, these loans are treated as if they are not subject to cross border (currency convertibility) risk. This factor is also addressed by the input page of the present invention.

Projects may further be characterized as having only a percentage of the project loan insured. For example, a given project loan may be insured 80% through comprehensive coverage, 10% through PRI, and 10% can be clean. This information can be entered as at 908 in FIG. 5B. In one embodiment of the present invention, if the tranche is covered with PRI only, the CRI details can be left blank. If the tranche is covered with CRI only, the PRI details can be left blank. If the tranche has comprehensive coverage, the details for both PRI and CRI can be input into the system. The provider of the insurance can also be specified as at 910, as well as the start and end date of the insurance coverage, as at 912. With regard to the term, the year in which the project begins operation is important because it affects when construction risks end and operating risks begin. If early repayment is expected, the expected call date can also be entered and the RIM of the present invention will perform an analysis to both the call and maturity dates.

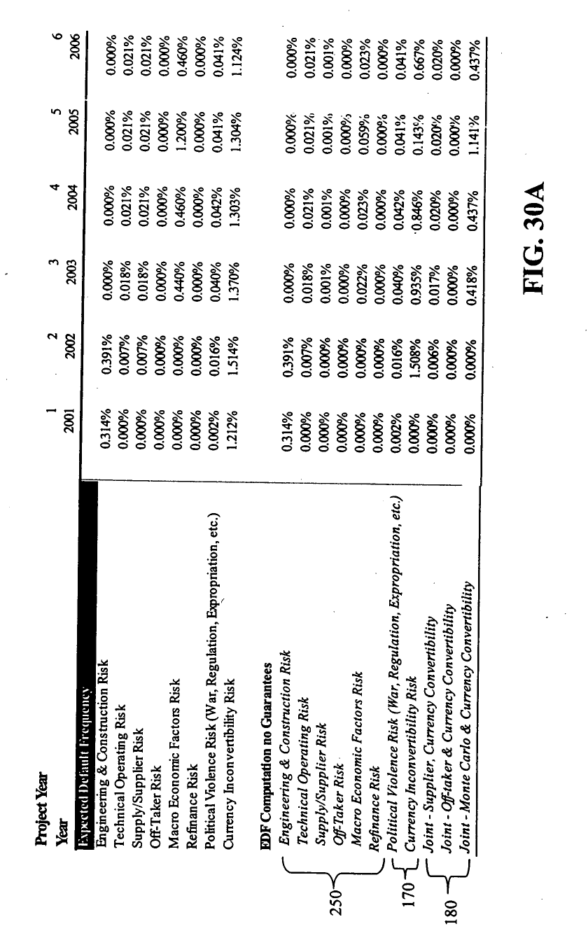

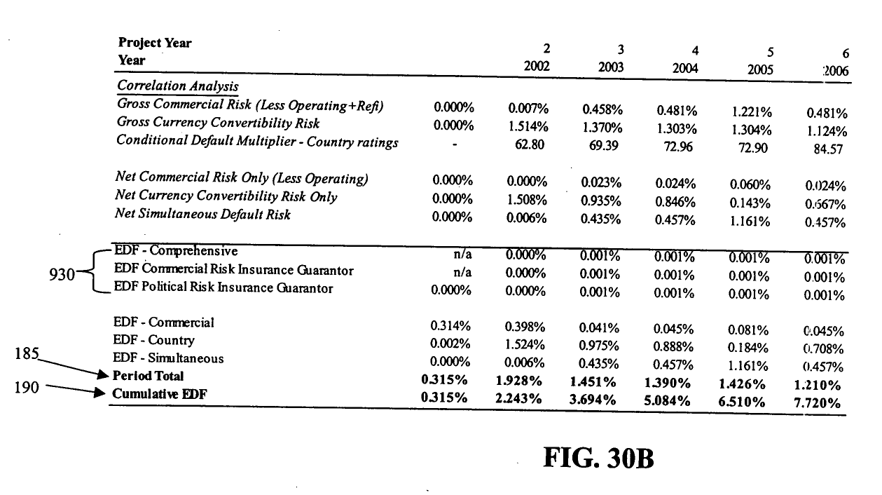

Provider identification 910 can be taken from a separate table shown in FIG. 7A which can have the provider 910 identified along with a corresponding risk rating 920. The type of insurance can have an associated EDF vector, as shown generally at 925 in FIG. 29 and can be considered in the determination of the overall project EDF as shown in FIG. 30B at 930. In one embodiment the credit rating of the gaurantor can be discounted to take into account difficulties in the structure of the guarentee contacts (e.g. the inability to appeal a denied claim).

Once this information is entered, the cumulative EDF for each insurance piece can be determined. This involves determining joint commercial and country EDF values. Joint commercial and country risk values represent the possibility that a project defaults for both country reasons and commercial reasons. By the present invention, consideration is given to the joint risk of supplier default and currency inconvertibility default, off-taker default and currency inconvertibility default, and macro-economic causation of default and currency inconvertibility default. Other joint risks may be considered as deemed appropriate. Computations can be performed to determine these joint probabilities, driven by correlation between risk factors, and the resulting EDF vectors can be combined with the individual risk factor EDF vectors in a table for each type of insurance coverage, an example of which is shown in FIGS. 30A and 30B.

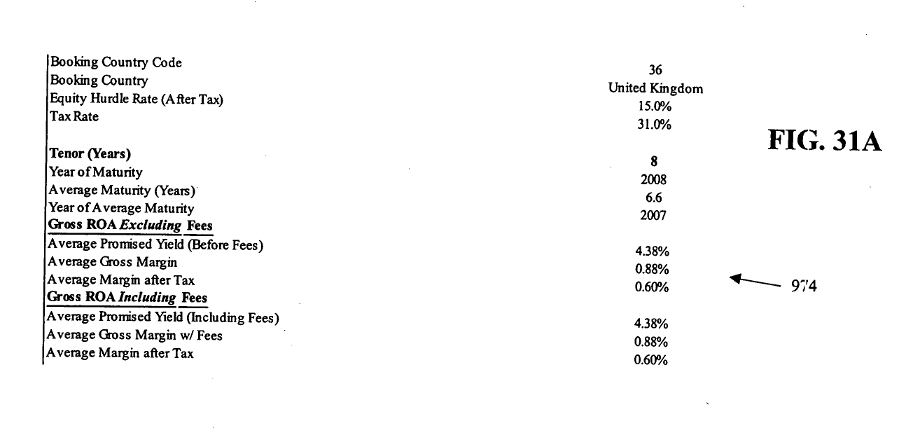

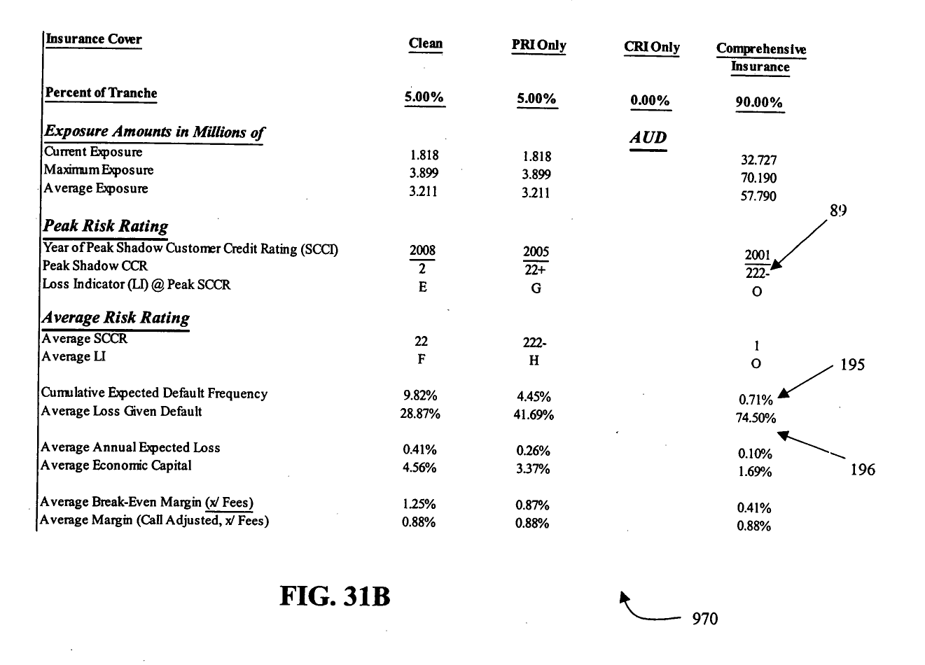

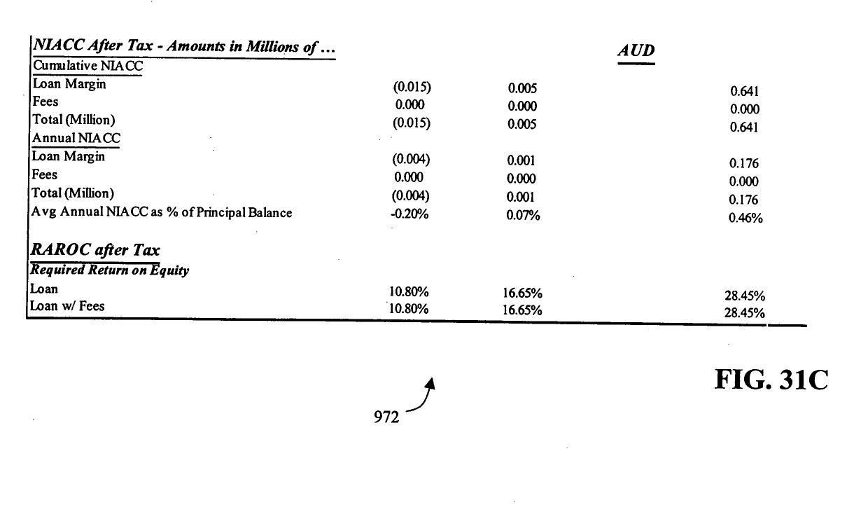

As shown in FIGS. 30A and 30B, the commercial risk factor EDFs can be grouped as at 250, the country risk factor EDFs can be grouped, as at 170, and the joint risk factor EDFs can be grouped as at 180. Calculations can be performed to obtain total EDF for each period, as at 185, and a cumulative value can be obtained, as at 190. Additional insurance factor EDF's 930 can also be included. These values are obtained for each of the insurance types involved, and a final calculated value for EDF for the project loan can be determined and output on a summary page, as shown by way of example at 195 in FIG. 31B.

The present invention thus considers all risk factors, singly and in combination, that can cause a project to default and thereby result in the inability to pay back a loan. From the EDF values obtained, other measures can be determined which further assist in the loan decision-maker's analysis.

Computing Loss Given Default (LGD)

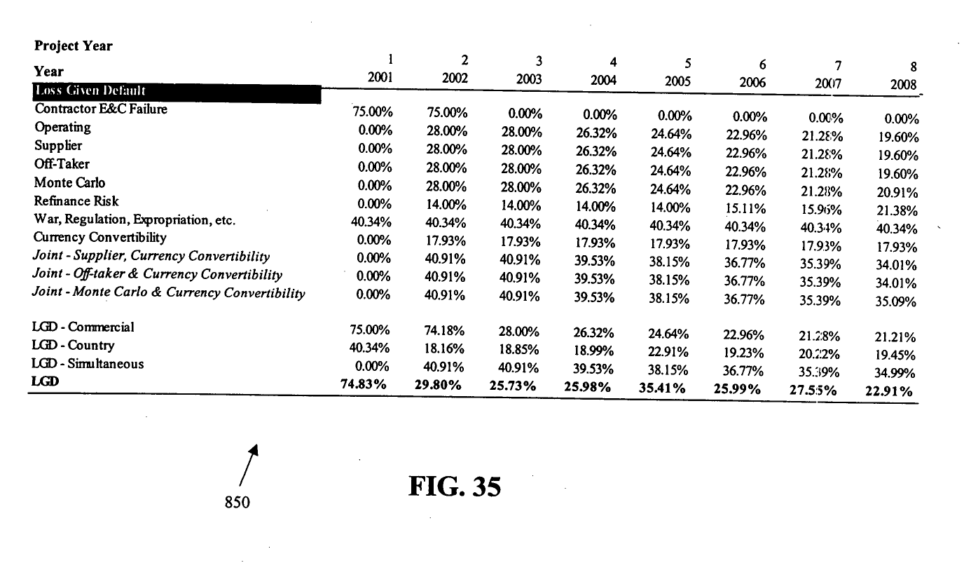

Loss Given Default (LGD) is dependent on the reason why a project defaults. Therefore, LGD is estimated for each type of risk. As described, the ways a project can default include contractor engineering and construction default, operating default, supplier default, off-taker default, default for macro-economic reasons, default through inability to obtain refinancing, political violence, currency inconvertibility, and combinations of several of the above. Once LGD values are obtained for each of the risk factors, they can be aggregated within a table 850, such as shown in FIG. 35 for each of the different types of insurance, and subsequently aggregated into a report, such as shown at 196 in FIG. 31B. The methods of determining LGD for each of the risk factors is described herein.

Contractor E&C Failure LGD

There are few available statistics for computing the LGD for a project during the construction phase. However, two specific extreme circumstances can be examined and included in the method of analysis involved with the present invention. First, if a sponsor does not put equity in until project completion and the construction firm does not provide liquidated damages, financial incentives do not exist for the sponsors to maximize recovery. Thus, if there is a failure during the development stage of a mine for example, all one has is a hole in the ground as there is little or nothing to recover. For a process plant, such as a refinery, factory, or power facility, one can argue that there is some scrap value to the facility. The amount one can expect to recover after expenses is nil. Therefore, in this circumstance, the LGD can be estimated for use with the present invention at 100%.

At the other extreme, if a sponsor puts equity in up front, and the contractor provides liquidated damages such that the total adds up to the total cost of the project, full recovery can be assumed with a corresponding LGD of 0%. For points in between, LGD can be estimated according to various assumptions. One assumption that can be used takes a straight line between the two extremes described above. For example, LGD=100%−(Equity as a % of total costs)−(Liquidated Damages as a % of total cost). The underlying assumption is that as the amount of equity and/or the commitment of liquidated damages increases, the more lenders are expected to recover in a default scenario.

Operating, Supplier, Offtaker and Refinance Failure LGD Estimate

The default Operating, Supplier and Offtaker LGDs are derived in part, from historical statistics. Three factors considered to drive LGD are (1) where the loan stands in the capital structure (see table 855 in FIG. 34); (2) the industry involved with the project (for example, senior unsecured utilities have a historical loss rate far below the LGD for senior unsecured financial institutions); (3) financial leverage; and (4) the physical location of the project. For example, the LGD for a project with a book debt/equity ratio of 80% will be higher than the LGD for the same project with a debt/equity ratio of 50%. In accordance with one embodiment of the present invention, to compute LGD through time, the LGD from the table 855 in FIG. 34 is taken and multiplied by the fraction of debt outstanding/original debt amount. Additionally, LGD values can be adjusted based on factors such as, for example, the LGD for a refinance failure being generally thought of as less than the LGD for operating or supplier default. For example, the LGD for a refinance failure can be considered as 50% of the LGD for operating or supplier default in one embodiment of the present invention. This is because the nature of the loss is different. In a refinance failure, the lenders may get 100% of their principal back, but may have to wait years to get that recovery and may earn an interest rate below market levels.

Computing LGD For Default Caused By Macroeconomic Factors

By running thousands of scenarios, for example, LGD can be determined by examining the cash flow generating ability of the project once default occurs. Default will generally occur given a difficult economic environment. To determine LGD, the cash flow generating power of the project is considered given this tough operating environment.

In one embodiment of the invention, for any one scenario, the LGD can be determined by first estimating the free cash flow of the project before debt service, discounting those cash flows at the appropriate rate reflecting the distressed nature of the project to determine the residual value of the cash flows. In one embodiment of the invention, the interest rate used can be the base rate plus the highest margin of all the tranches in the deal+800 basis points. In a specific embodiment, such as for a mining project, for example, approximately 900 to 1,000 basis points can be added since recovery can be more difficult in mining projects. Next the cost of restructuring (i.e. the Country LGD) can be deducted to get Net Free Cash Flows which can be computed and displayed on the input page of the RIM. Dividing the value of the Net Free Cash Flow by the value of the debt outstanding (including accrued interest) yields the percent recovered. The maximum considered, in one embodiment, is 100%. The percentage LGD can then be computed with the following equation:
LGD=100%−% Recovered

Thus, when default is observed in the Monte Carlo analysis, the LGD can be computed through the following steps: (1) Compute the present value of the projects free cash flow after tax; (2) Compute the ratio of the PV−Free Cash Flow/Value of Debt; and (3) Take (2) above and subtract a cost of recovery (this percentage is the same as a cross border default LGD). Note that this is the LGD of just one scenario. The LGD estimate for any one-year is the average of all LGDs observed for that year.

Country LGD

Country risks are important to identify because, when default occurs, the cost of recovery is impacted by the physical location of the project. All things being equal, the amount lenders can recover in a developing country is far lower than the amount that lenders can expect to recover if the project were in a developed country. Such factors as government interference, corruption in the legal system or simply the lack of transparency or a bankruptcy law, for example, all contribute to the cost of loan recovery. How a project fits into the economic development plans of the host government, the financial participation of influential third parties, and the project's ability to generate foreign currency reserves or reduce the country's need to spend foreign currency reserves on imports, can have an effect on the recoveries during the work-out of a commercial default.

It is important to split country EDF into its component parts as the LGD for cross border default differs from the LGD for a default caused by political violence. The country's particular CRI rating can also be used, along with other items, to determine both a political violence loss factor and cross border loss factor for the given country. A low CRI corresponds to a low recovery rate (i.e. high LGD), while a high CRI corresponds to a high recovery rate (i.e. low LGD). In one embodiment, the political violence LGD is unadjusted for mitigants. In one embodiment, in estimating a cross border LGD, other factors can be considered, including the presence or lack of an influential guarantor for any of the loans to the project, and the relative national importance of the project. These factors are considered as both country and commercial loss mitigants, shown generally at 280 in FIG. 5B. With regard to the guarantor 136, a score can be determined based upon whether the guarantee is from a multilateral (such as ADB, IDB, IFC, World Bank, etc.), an ECA (Export Credit Agency) or a local bank, whether the guarantee includes participation by a local bank, whether the guarantee is from the sponsor, or whether the guarantee is non-existent. The national importance factor 140 also can present a score depending upon whether the project is a critical export (such as oil and gas, or mining, for example), an import substitution (such as fertilizer, for example), a critical domestic (such as water, power, telecommunications, for example), a moderate (such as automobile or steel manufacturing, for example), or a marginal project (such as a tooth paste factory, for example). Once classified, the appropriate category can be added to the input page of the present invention.

In another embodiment, the cross border LGD can be estimated based on a statistical analysis of historical country defaults and reschedulings controling for such factors as (but not exclusively) reserves relative to imports, GDP per capita and total debt stock relative to exports. The relationship can give an expected cross border LGD given the financial condition of the country.

Political Violence LGD

In one embodiment of the invention, this can be derived from the Euromoney Country Risk Index, an example of which is shown in the table 120 in FIG. 10. Thus, LGD Political Violence=(100−EM CRI).

Cross Border LGD

More than one method can be employed in accordance with the present invention to estimate cross border LGDs. One method uses the formula: Cross Border LGD=LGD PV*(Guarantee Factor)*(National Importance factor). The guarantee factor 136 and the national importance factor 140 can be combined with the Political Violence LGD to determine Cross Border LGD. FIG. 11 shows an example table which can be used in determining Cross Border LGD.

Alternatively, for cross-border LGD, historical loss rates can be used. Bank debt is renegotiated at the London Club. Loss in rescheduling can occur by a direct write down of the debt or a reduction in the interest charge. It can also take the form of an elimination of interest for a specified period of time. Based on an analysis of these rescheduling, the LGD can be explained by
1) The level of reserves/imports
2) Per capita GDP
3) Total debt/exports
   Based on a regression analysis of these factors compared to the historical LGDs observed at the London Club, estimates for cross border LGDs can be determined.
   Joint Probabilities

If the project defaults for two reasons simultaneously, the LGD is expected to be worse than if just one reason exists. Therefore, the loss is estimated by compounding the LGDs discussed above, with the following formula: LGD Joint=1−(1−LGD[1])(1−LGD[2)).

As with EDF, a table can be developed in connection with the present invention which represents LGD for each insurance piece. FIG. 35 shows an example of such a table 850. Using a similar method to that described for EDF in connection with the various forms of insurance, the total LGD factor can be determined and reported on a summary page as shown at 196 in FIG. 31A. In this embodiment, LGD is shown as a weighted average.

Standard Deviation of LGD

Standard deviation is estimated by defining a 100% loss as a 4 standard deviation event.

Standard deviation=(100%−LGD)/4. This method is used for all risk factors except for the Macro Economic risks. When a Monte Carlo is executed, an LGD is computed for each year. This represents the average LGD observed for all the scenarios run. The standard deviation of LGD is computed by applying the traditional standard deviation equation to the LGDs observed in the Monte Carlo exercise.

Other Measures

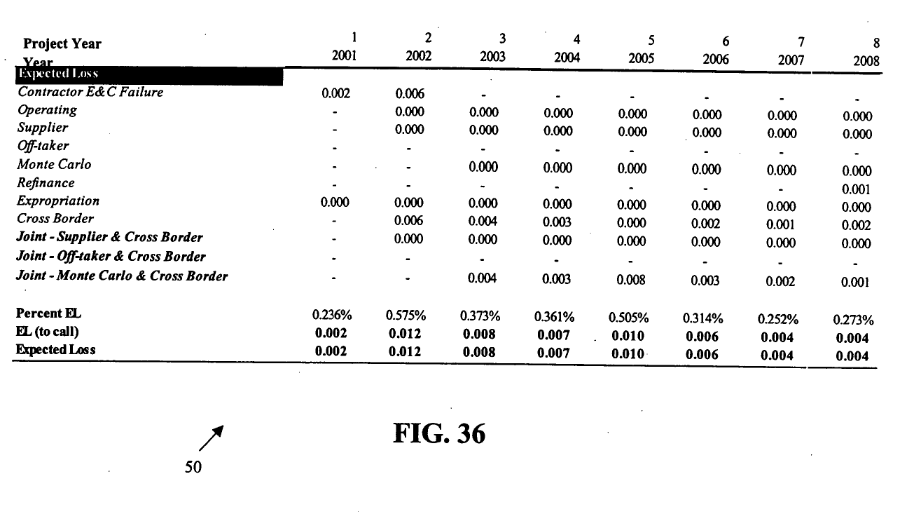

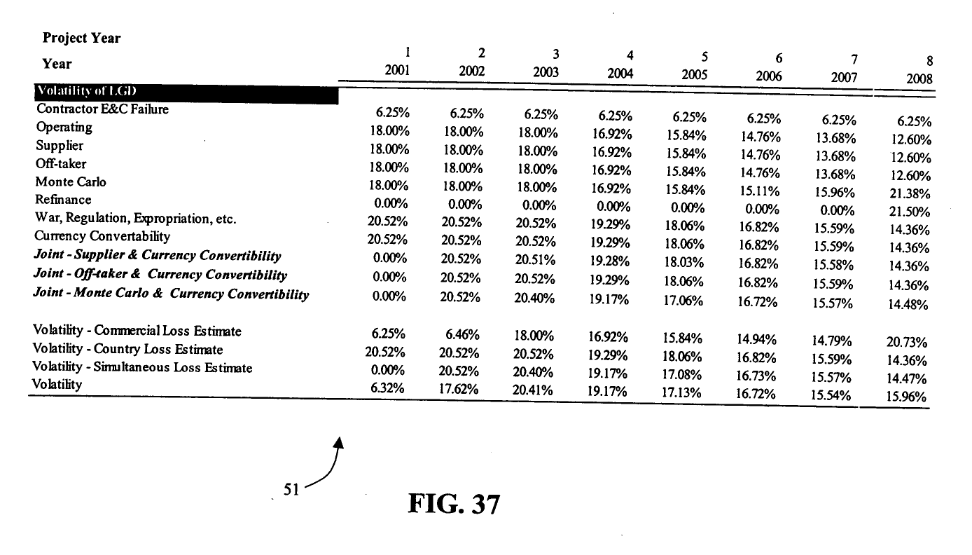

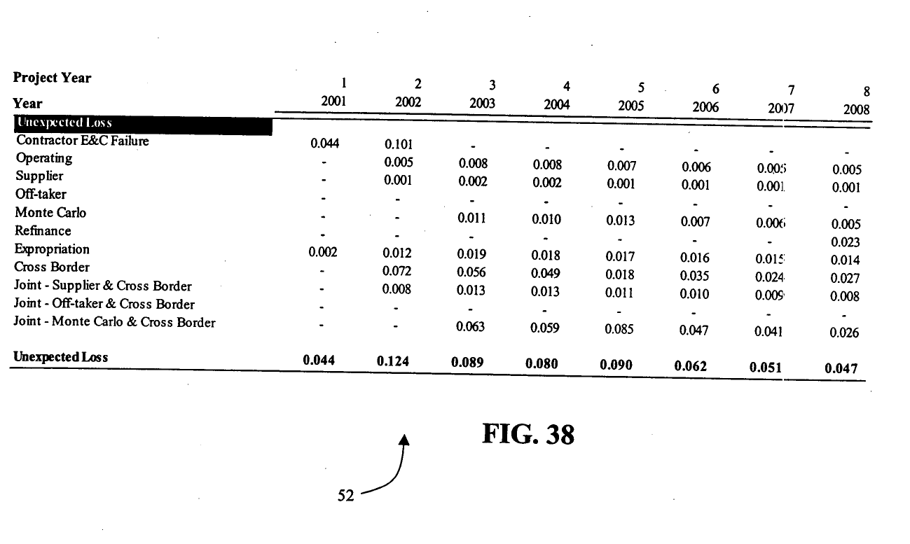

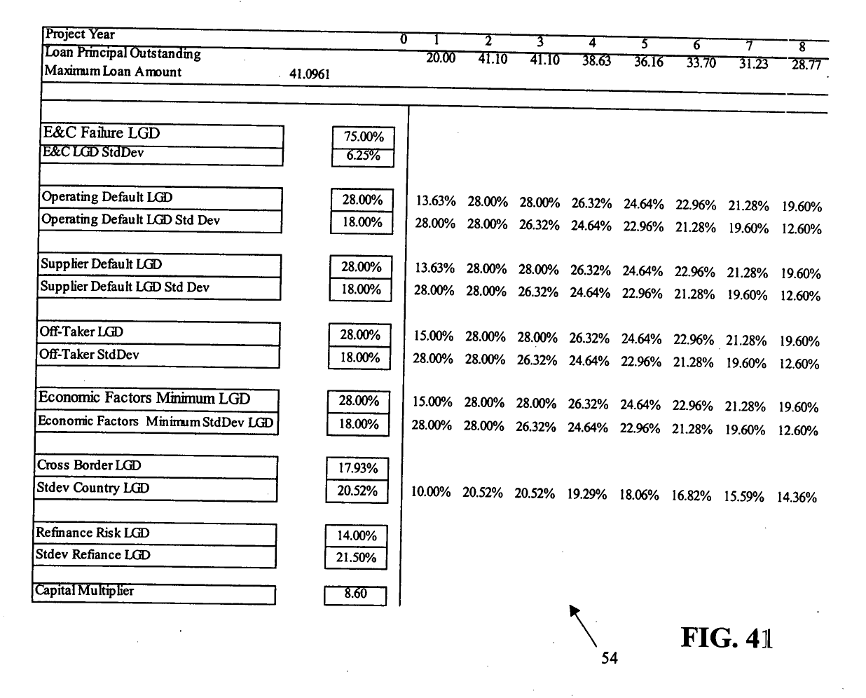

In addition to EDF and LGD measures, other measures which are determined by the system and method of the present invention include the unexpected loss, the expected loss, the volatility of the loss given default. These measures can be determined in connection with cash flow, exposure amount, and other elements as described herein, and can be represented in tables 50, 51, and 52 as shown, for example, in FIG. 36 (expected loss), FIG. 37 (volatility of LGD), and FIG. 38 (unexpected loss), respectively. In computing Volatility of LGD, for example, the system of the present invention can apply the standard deviation function to the percent LGD for each defaulted scenario. In one embodiment of the invention, a computer system having a user-defined function can be employed to perform this calculation. The LGD and standard deviations of LGD can be tabulated in an assumptions rating table 54 having associated vectors as shown in FIG. 41, for example.

Results

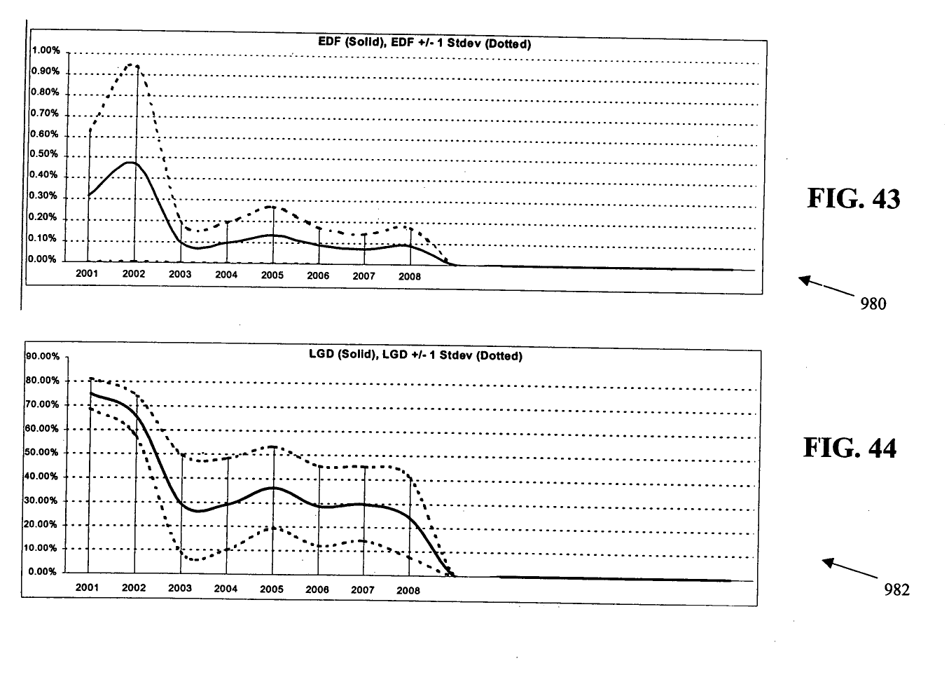

Once the EDF, LGD, and VoL measures have been determined, further analysis can be conducted, and graphs and reports can be generated which will assist the decision-maker in the loan analysis. FIGS. 31A, 31B and 31C show sample results pages (shown at 970, 972, and 974, respectively) in accordance with the present invention. In addition to the result summary page(s), the system of the present invention can produce a series of graphs which describe the performance of the loan over its contracted life. FIGS. 43 through 50 are examples of these graphs. As shown in FIG. 43, the EDF chart 980 gives a pictorial view of the default risk profile of a sample project over time. The charts demonstrating the risk and profitability profile of the loan can include the contribution of the insurance coverage.

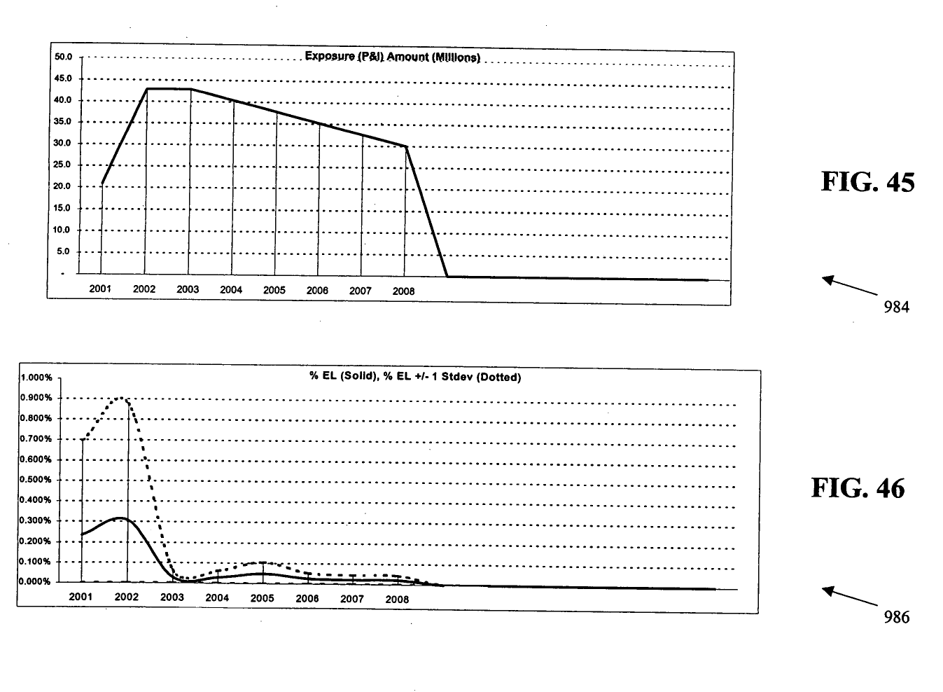

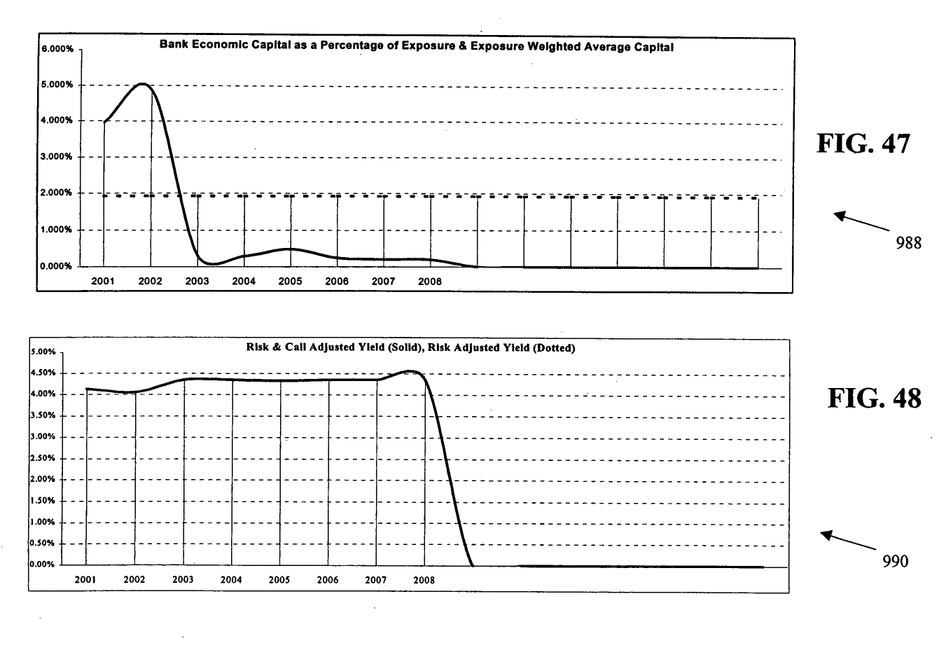

FIG. 44 shows an LGD chart 982 giving a pictorial view of the Loss Given Default profile of a sample project over time. As shown in FIG. 45, the exposure profile 984 shows the contracted drawn loan amount over the life of a sample project. As shown in FIG. 46, the Expected Loss chart 986 gives a pictorial view of the changing Loss Profile over the life of a sample project. As shown in FIG. 47, the Economic Capital (EC) chart 988 gives a pictorial view of the amount of capital that should be put aside to support the default risk of a sample loan. In most cases, EC will be the highest at or near the point of maximum EL. As shown in FIG. 48, Risk Adjusted Yield 990 is defined to be the Nominal Yield less EL (dotted line) and represents the income the lender can expect to earn on the sample loan on a risk adjusted basis. Should the credit risk of the loan improve over time, the risk of early repayment increases, reducing the probability the lender will earn a high margin. Risk and Call Adjusted Yield is defined to be the Risk Adjusted Yield less the Risk of Prepayment (solid line) and this represents the return which can be expected on a risk and call adjusted basis. Risk and Call Adjusted Margin (FIG. 49) repeats this analysis examining the loan margin only, as shown by way of example at 992.

Profitability Elements

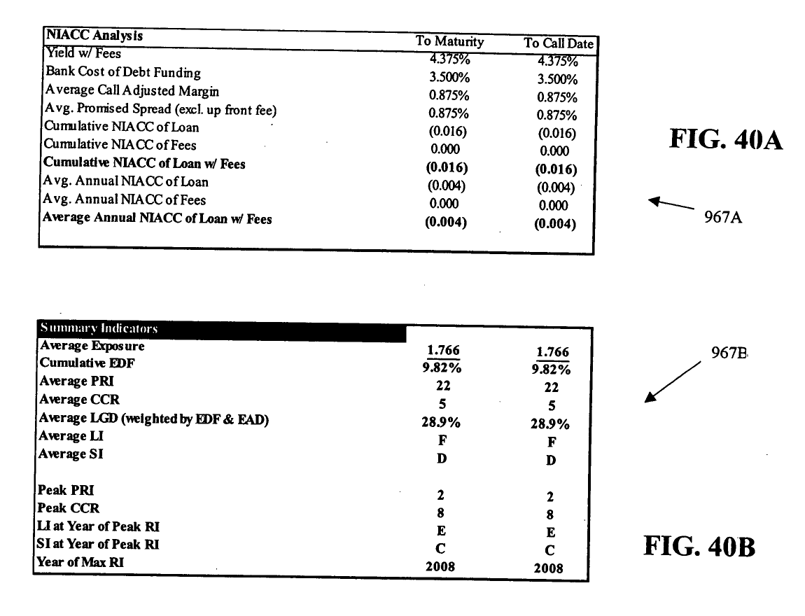

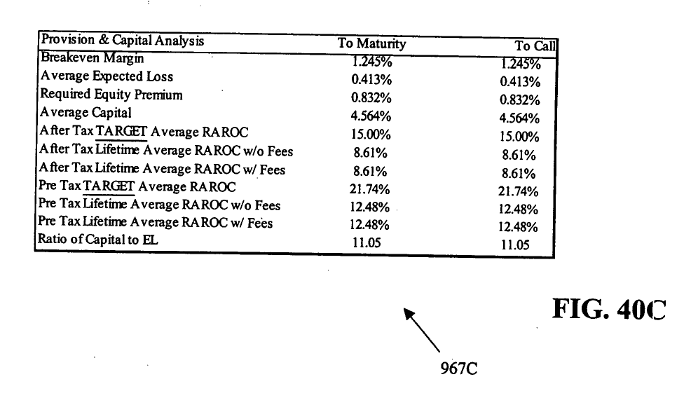

In addition to generating reports and graphs showing risk measure information in connection with a prospective loan, the present invention can be used to analyze provisioning and profitability measures. For example, once EDF, LGD, and VoL have been determined in connection with a prospective loan, provisioning and economic capital measures can be determined, as well as net income after cost of capital (NIACC), risk-adjusted return on capital (RAROC), and return on assets (ROA). FIGS. 40A, 40B and 40C show respective portions 967A, 967B, and 967C of a sample summary results page showing sample values for various measures.

NIACC as a percentage of principal balance provides an analysis of the profitability profile of the loan over its life. Since EL and Economic Capital rise over the life of this loan, NIACC falls over time. This is shown in sample output graph 994 in FIG. 50.

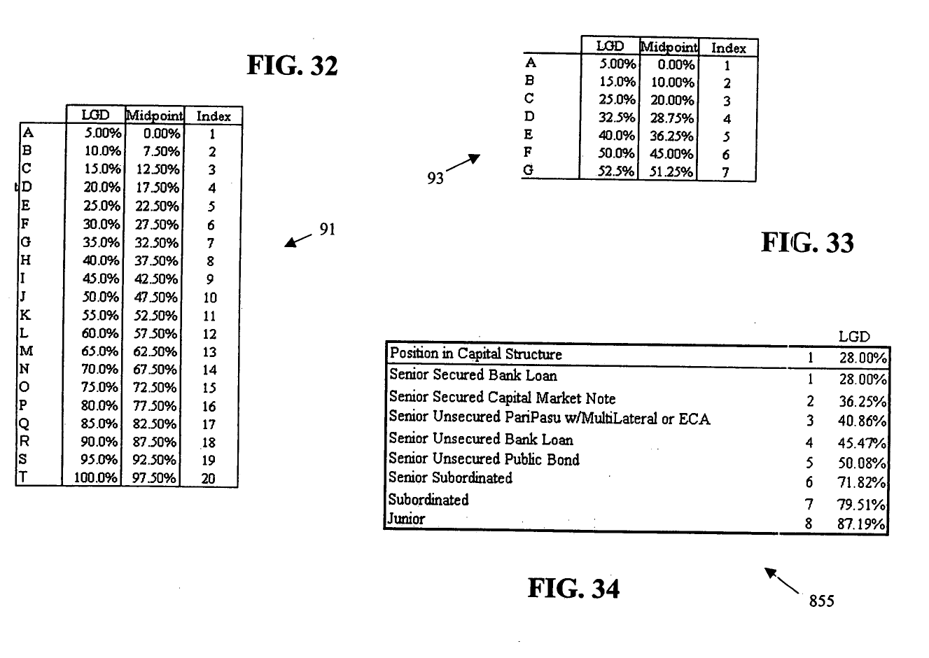

Additional measures such as an overall customer credit rating and a shadow customer credit rating can be taken from columns 87 and 89, respectively in FIG. 4, and reported as shown in FIG. 31B. Also, a loss indicator rating, and a security indicator rating can be reported. The security indicator rating can be based upon what assets the lender has security over which can be taken in a bankruptcy, including the percentage of assets covered, for example. The loss indicator rating and the security indicator rating can also be based upon the LGD value obtained earlier, and can be represented as shown in tables 91 and 93 in FIGS. 32 and 33, respectively.

Net income after cost of capital can be determined as follows. For any one year, NIACC is computed by taking the net margin and subtracting expected loss and economic capital charge. Net margin equals the gross rate less a base rate, such as LIBOR. Economic capital charge equals the product of economic capital and the required return on equity. This determination can be represented as:

| | |
|---|---|
| | Net Margin (= Gross rate less a base rate such as LIBOR) |
| Less: | Expected Loss |
| Less: | Economic Capital Charge (= Economic Capital × Required |
| | Return on Equity) |
| Equals: | NIACC |

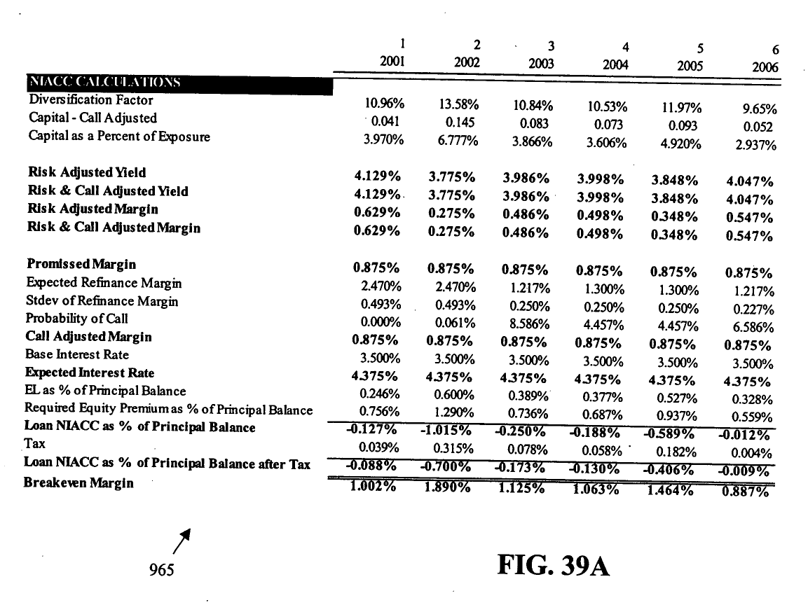

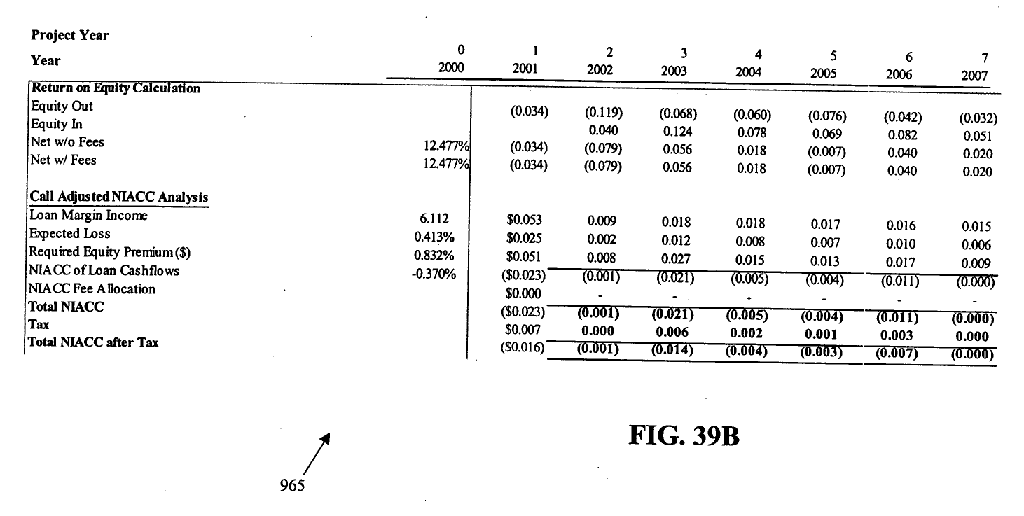

Since loans considered in connection with the present invention can be outstanding for a number of years, the cumulative or total NIACC can be determined as the present value of the NIACCs earned each year over the life of the loan, discounted at the Required Return on Equity. A sample NIACC computation page 965 is shown in FIGS. 39A and 39B.

In one embodiment of the invention, loans are examined on an annual basis and on an equal time period basis. In another embodiment of the invention, computations can be conducted on a semi-annual, quarterly, monthly, or other time period basis. The present invention can also be adapted to handle uneven time periods.

The Return on Equity (ROE) is the internal rate of return on cash flows on lender equity. The economic capital represents the equity the bank must put up at the beginning of the period under review. This is cash out flow.

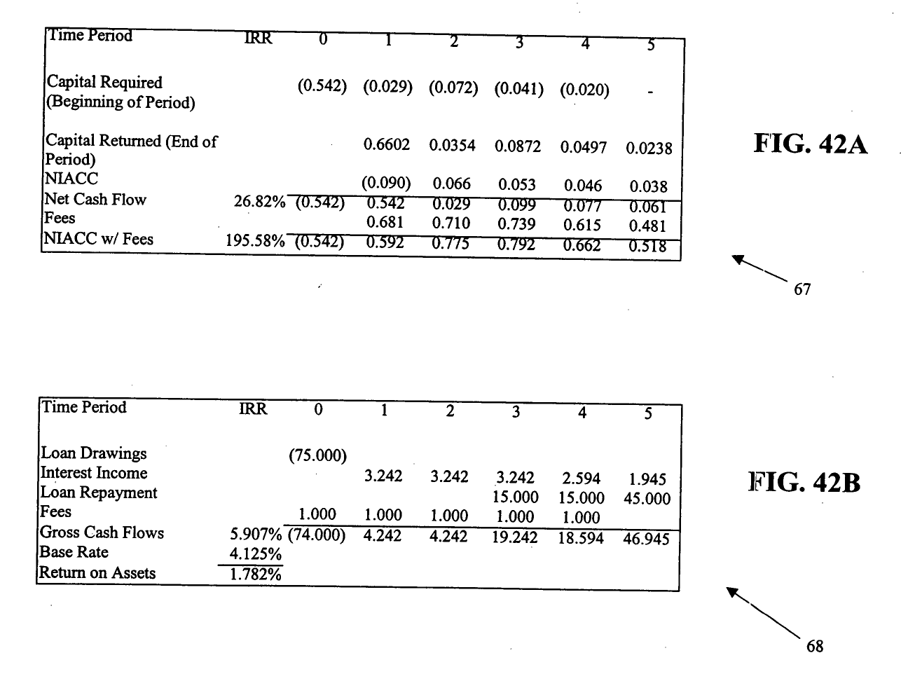

Cash inflow is equal to the return on capital plus a return of the capital put up. The preceding describes the computation for a single period. For multiple periods, the process is repeated over multiple periods representing the life of the loan. Any fees which are required can be added in and an IRR computed. FIG. 42A shows a sample NIACC computation in table 67.

Computing Return on Assets

Return on assets is computed by taking the IRR of Gross Cash Flows and subtracting the Base Lending rate (such as LIBOR). In essense, it is the average margin, plus fee income spread over the life of the loan (even if it is paid all in 1 period). If Fees are zero, Return on Assets is simply the average loan margin. FIG. 42B shows a sample Return on Assets calculation in table 68.

The nominal cash flow of the fees is shown as different in the two computations. To compute Return on Assets, the actual fees and payment date of those fees in the computation can be used. Computing return on equity, the cash flows over the life of the loan can be spread out assuming the fees are deposited in a bank account, earning the base rate (LIBOR) and paid out over time weighted by the loan amount outstanding. The bank does this to spread the fee income out over the life of the loan. From a practical standpoint, it is possible to have fees in excess of the economic capital requirement. When this occurs, the loan is essentially self-capitalizing, resulting in an infinite ROE. The smoothing eliminates this possibility in all but the most extreme cases.

It can thus be seen that by the present invention there is provided a valuable system and method which can take inputs related to country and commercial risk associated with a prospective loan and produce significantly accurate risk and profitability measures to be used in evaluating the prospective loan.

The invention may be embodied in other specific forms without departing from the spirit or essential characteristics thereof. The present embodiments are therefore to be considered in all respects as illustrative and not restrictive, the scope of the invention being indicated by the claims of the application rather than by the foregoing description, and all changes which come within the meaning and range of equivalency of the claims are therefore intended to be embraced therein.

1. A method for evaluating a loan for a borrower, comprising the steps of:
providing at least one loan risk element table projecting a set of values for at least one loan risk element over a given time period and over a given range of risk ratings;
providing at least one commercial risk factor rating scale, said scale having a plurality of risk ratings corresponding to a plurality of possible risk factor values;
receiving input related to at least one country risk factor and at least one commercial risk factor;
determining, from said input and said rating scale, a country risk factor rating and a commercial risk factor rating;
determining, from said country risk factor rating and said commercial risk factor rating and said at least one table, a respective corresponding set of values for said at least one risk element;
determining a total value for said at least one risk element; and
generating at least one report characterizing risk associated with said loan.

2. The method of claim 1 wherein said at least one risk element is estimated default frequency (EDF).

3. The method of claim 1 wherein said at least one country risk factor is a country ceiling rating.

4. The method of claim 1 wherein said at least one country risk factor is a measure of political violence risk.

5. The method of claim 1 wherein said at least one country risk factor is a measure of cross-border currency risk.

6. The method of claim 1 wherein said at least one commercial risk factor is a factor taken from the group of factors consisting of: supplier risk, off-taker risk, construction risk, operating risk, refinance risk.

7. The method of claim 1 wherein said set of commercial risk factor values for said at least one loan risk element includes values generated in connection with an analysis of at least one macro-economic risk factor.

8. The method of claim 7 wherein said at least one macro-economic risk factor is a factor taken from the group of factors consisting of: foreign exchange rates, interest rates, off-take volume, supply costs, inflation rate, commodities prices.

9. The method of claim 7 wherein said set of values for said at least one loan risk element associated with said at least one macro-economic factor is generated via a Monte Carlo process.

10. The method of claim 1 wherein the step of receiving input includes the step of receiving information identifying the existence of at least one type of insurance coverage.

11. The method of claim 10 wherein a plurality of insurance coverage types are identified and wherein said total value for said at least one risk element is determined by aggregating respective total values for said at least one loan risk element determined in connection with each of said plurality of insurance types.

12. The method of claim 10 wherein said at least one insurance type is a type taken from the group of insurance types consisting of: political risk insurance, commercial risk insurance, comprehensive risk insurance; no insurance; insurance associate with “B” loan programs.

13. The method of claim 1 further including the step of determining a value for at least one additional risk element.

14. The method of claim 13 wherein said at least one additional risk element is loss given default (LGD) and wherein said value is determined by aggregating respective LGD values for said at least one country risk factor and said at least one commercial risk factor.

15. The method of claim 14 wherein said LGD values for said at least one country risk factor and said at least one commercial risk factor are determined by comparing said determined respective risk factor ratings with a LGD table projecting sets of values over a given time period and a given range of risk ratings.

16. The method of claim 14 including the steps of receiving loan placement input regarding where said loan exists within said borrower's capital structure, and providing a loan placement rating scale having a plurality of LGD values corresponding to a plurality of loan placement inputs, wherein said LGD values for said at least one country risk factor and said at least one commercial risk factor are determined by comparing said loan placement input to said loan placement rating scale.

17. The method of claim 16 including a plurality of loan placement scales, wherein said plurality of loan placement rating scales correspond to a plurality of industry types.

18. The method of claim 14 wherein said LGD value is determined by calculating the cash flow generating ability of the project associated with said loan once default occurs.

19. The method of claim 1 further including the step of determining at least one profitability measure.

20. The method of claim 19 wherein said at least one profitability measure is taken from the group of profit measures consisting of: net income after cost of capital, risk-adjusted return on capital, return on assets.

21. The method of claim 13 wherein said at least one additional risk element is taken from the group consisting of: expected loss, economic capital, unexpected loss (volatility of loss).

22. The method of claim 1 including the step of generating a security indicator rating and a loss indicator rating.

23. The method of claim 1 including the further step of generating at least one graph characterizing risk associated with said loan.

24. The method of claim 1 including the further step of generating at least one report characterizing profitability associated with said loan.

25. A system for evaluating a loan for a borrower, comprising:
an input component for receiving input information related to at least one commercial risk factor and at least one country risk factor;
a conversion component capable of generating a first value for at least one loan risk element, said first value being based upon said input associated with said at least one country risk element, said conversion component also being capable of generating a second value for said at least one loan risk element, said second value being based upon said input associated with said at least one commercial risk element;
a computation component capable of determining a summary value for said at least one loan risk element; and
a report generation component capable of generating a report characterizing risk associated with said loan.

26. The system of claim 25 wherein said at least one risk element is estimated default frequency (EDF).

27. The system of claim 25 further including a computer simulation program for generating multiple discrete outcomes to a loan event having given factors, said factors including at least one macro-economic factor, said program being capable of receiving information related to said at least one macro-economic factor and from the outcomes generated, determining a third value for said at least one loan risk element.

28. The system of claim 25 wherein said conversion component includes a score assignment component for assigning a score to said at least one commercial risk factor based on said input information.

29. The system of claim 25 wherein said at least one country risk factor is a country ceiling rating.

30. The system of claim 25 wherein said at least one country risk factor is a measure of political violence risk.

31. The system of claim 25 wherein said at least one country risk factor is a measure of cross-border currency risk.

32. The system of claim 25 wherein said at least one commercial risk factor is a factor taken from the group of factors consisting of: supplier risk, off-taker risk, construction risk, operation risk, refinance risk.

33. The system of claim 25 wherein said at least one macro-economic risk factor is a factor taken from the group of factors consisting of: foreign exchange rates, interest rates, off-take demand, supply costs, inflation rates, commodities prices.

34. The system of claim 25 wherein said simulation program generates said set of values for said at least one loan risk element via a Monte Carlo process.

35. The system of claim 25 wherein said input component is capable of receiving information identifying the existence of at least one type of insurance coverage.

36. The system of claim 35 wherein said computation component is capable of determining a total value for said at least one risk element by aggregating respective total values for said at least one loan risk element determined in connection with said at least one insurance type.

37. The system of claim 35 wherein said at least one insurance type is a type taken from the group of insurance types consisting of: political risk insurance, commercial risk insurance, comprehensive risk insurance, no insurance, insurance associated with “B” loan programs.

38. The system of claim 25 further including a component for determining a value for at least one additional risk element.

39. The system of claim 38 wherein said at least one additional risk element is loss given default (LGD) and wherein said determination component is capable of aggregating respective LGD values for said at least one country risk factor and said at least one commercial risk factor.

40. The system of claim 25 wherein said input component is capable of receiving loan placement input regarding where said loan exists within said borrower's capital structure, and wherein said conversion component includes a loan placement rating scale having a plurality of LGD values corresponding to a plurality of loan placement inputs, said conversion component being capable of generating LGD values for said at least one country risk factor and said at least one commercial risk factor by comparing said loan placement input to said loan placement rating scale.

41. The system of claim 25 further including a profitability measure determination component.
capable of determining at least one profit measure, said at least one profitability measure being taken from the group of profitability measures consisting of: net income after cost of capital, risk-adjusted return on capital, return on assets.

42. The system of claim 38 wherein said at least one additional risk element is taken from the group consisting of: expected loss, economic capital, unexpected loss (volatility of loss).

43. The system of claim 25 including a graph generation component capable of generating at least one graph characterizing risk associated with said loan.

44. The system of claim 25 wherein said report generation component is capable of generating at least one report characterizing profitability associated with said loan.

45. A computer-implemented process for evaluating a non-recourse loan, comprising the steps of:
collecting risk data;
developing a predictive model from said risk data;
storing the predictive model;
obtaining individual project risk data, including risk factor values for at least one commercial risk factor and at least one country risk factor;
inputting said individual project risk data into said stored predictive model; and
generating a report characterizing risk and profitability associated with said loan.

46. The process of claim 45 wherein said at least one country risk factor is a factor taken from the group of factors consisting of: political violence risk, currency inconvertibility risk.

47. The process of claim 45 wherein said at least one commercial risk factor is a factor taken from the group of commercial risk factors consisting of: construction risk, operating risk, supply risk, off-taker risk, re-finance risk.

48. The process of claim 45 wherein the step of generating a report includes characterizing risk in terms of at least one risk measure, said at least one risk measure being a measure taken from the group of measures consisting of: estimated default frequency, loss given default, volatility of loss given default.

49. The process of claim 45 wherein the step of generating a report includes characterizing profitability in terms of at least one profitability measure, said at least one profitability measure being a measure taken from the group of measures consisting of: net income after cost of capital, risk adjusted return on capital, return on assets.

50. A computer system for evaluating a non-recourse loan, comprising:
an input device capable of receiving loan risk data, including data associated with at least one country risk factor and data associated with at least one commercial risk factor;
a memory having a database storing said loan risk data;
a processor capable of calculating an output value for at least one loan risk measure, based on said loan risk data; and
an output device capable of producing at least one report and at least one graph characterizing said at least one loan risk measure.

51. The system of claim 50 wherein said processor is capable of calculating an output value for at least one loan profitability measure, based on said loan risk data, and wherein said output device is capable of producing at least one report and at least one graph characterizing said at least one loan profitability measure.

52. A method for evaluating a prospective non-recourse loan to a borrower, comprising the steps of:
providing at least one loan risk element table projecting a set of values for at least one loan risk element over a given time period and over a given range of risk ratings;
providing at least one loan risk factor rating scale having a plurality of risk ratings corresponding to a plurality of possible factor values;
providing country risk information, including a country adjustment factor table for identified countries;
providing input information related to country risk elements associated with said loan, said input information including at least one country designation, loss mitigation information, a previously determined percentage of total revenue which is hard currency export revenue, and a previously determined percentage of total debt represented by hard currency borrowings;
determining a country adjustment factor based on said country risk information for said inputted information;
determining, using said country adjustment factor and said at least one table, a set of values for said at least one loan risk element associated with a political violence risk factor, and a set of values over a given time range for said at least one loan risk element associated with a currency inconvertibility risk factor;
providing input information related to construction and development phase risks, including contractor credit rating, contractor experience, maximum contractor liquidated damages as a percentage of project cost, existence of third party completion guarantee or sponsor contingent equity, completion guarantor credit rating, the percentage of debt covered by the completion guarantor, and the construction progress;
said input information related to said construction and development phase risks further including a designation of project type, technology reliability factor, sponsor credit rating, sponsor equity contributions payment schedule type, sponsor equity contribution as a percentage of project cost, and a designation of the position of said loan tranche in the capital structure of said borrower;
determining, from said inputs and said at least one table and at least one scale, a set of values over a given time range for said at least one loan risk factor associated with said construction and engineering risk factor;
providing input information related to operating/technical phase risks, including the type of insurance coverage, the percentage of said loan to which said insurance applies, the beginning and end dates of the coverage of said insurance, a designation as to whether said insurance is an IFC, LADB, or ADB “B” loan, and a designation as to whether any political risk insurance includes extended coverage;
providing input information related to supply risk, including a designation of the primary commodity to be supplied and transportation requirements for supplied commodity;
providing input information related to off-taker risk, including a designation of the off-taker credit rating, a designation of whether there is easy substitution of off-takers, and a designation of whether the off-taker is the central government or a government-owned entity;
determining, from said input information, said at least one table and said at least one scale, a set of values over a given period of time for said at least one loan risk element associated with said operating and technical risk factor, as well as a set of values associated with said off-taker and supplier risk factors;
providing an historic rating migration table related to probabilities of a given sponsor and a given off-taker migrating to a rating which will result in a failed effort to gain refinancing;
providing a probability table projecting a set of values representing probabilities that a project rating will deteriorate to a point which will result in a failed effort to gain refinancing;
providing input information related to refinancing risk, said refinance risk input information including a sponsor credit rating;
determining, from said input information and said tables, a plurality of sets of values for said at least one loan risk element associated with said refinance risk factor;
inputting project timing factors, including a project evaluation date, a year of project start-up, a year said loan matures, and an expected call date;
inputting rate-related information, including a base loan interest rate, a booking point, a hurdle rate, and an effective tax rate, said hurdle rate and said tax rate being based upon said booking point;
providing a computer simulation program capable of generating multiple discrete outcomes to a loan event having a given value for at least one macro-economic factor;
inputting information related to said at least one macro-economic factor into said computer simulation program;
running said simulation program;
generating from said simulation program a set of values for at least one loan risk element over a given period of time, said values being associated with said macro-economic risk factor;
for each of said insurance types, determining a first set of values over a given range of time for said at least one loan risk element associated with said country risk, a second set of values over a given range of time for said at least one loan risk element associated with said commercial risk, and a third set of values over a given range of time for said at least one loan risk element associated with a joint country and commercial risk, and performing computations with said first, second, and third sets of values so as to produce a total set of values and a cumulative value for said at least one loan risk element associated with each of said insurance types;
computing a final value for said at least one loan risk element according to the percent allocation of each type of insurance for said loan;
determining from said final value for said at least one loan risk element, said project timing factors, and said rate related information, at least one profitability measure;
generating a report characterizing risk and profitability associated with said loan.
